(19) United States
(12) Patent Application Publication
(10) Pub. No.: US 2024/0422832 A1
(43) Pub. Date: Dec. 19, 2024

(54) METHOD AND DEVICE FOR WIRELESS COMMUNICATION

(71) Applicants: Yu CHEN, Shanghai (CN); Xiaobo ZHANG, Shanghai (CN)

(72) Inventors: Yu CHEN, Shanghai (CN); Xiaobo ZHANG, Shanghai (CN)

(73) Assignee: SHANGHAI LANGBO COMMUNICATION TECHNOLOGY COMPANY LIMITED, Shanghai (CN)

(21) Appl. No.: 18/822,507

(22) Filed: Sep. 3, 2024

Related U.S. Application Data
(63) Continuation of application No. PCT/CN2023/081198, filed on Mar. 14, 2023.

(30) Foreign Application Priority Data
Mar. 14, 2022 (CN) 202210249357.8

(51) Int. Cl. H04W 74/0833; H04W 76/30; H04W 88/04

(52) U.S. Cl. CPC H04W 74/0833; H04W 76/30; H04W 88/04

(57) ABSTRACT

The present application provides a method and device for wireless communications, comprising receiving a first signaling; the first signaling is used to indicate that a main path of SRB1 (Signaling Radio Bearer 1) is associated with a first radio link; the SRB1 is respectively associated with the first radio link and the second radio link; after receiving the first signaling, detecting failure occurred in the first radio link; as a response to the behavior of detecting failure occurred in the first radio link, executing a first operation set, the first operation set being related to whether one of the first radio link and the second radio link is for a U2N (UE to Network) relay. Through the first signaling and the first message, the present application helps to optimize the network in improving the communication reliability and avoiding the communication interruption.

### CROSS REFERENCE TO RELATED APPLICATIONS

The present application is the continuation of the international patent application No. PCT/CN2023/081198, filed on Mar. 14, 2023, and claims the priority benefit of Chinese Patent Application No. 202210249357.8, filed on Mar. 14, 2022, the full disclosure of which is incorporated herein by reference.

### BACKGROUND

### Technical Field

The present application relates to transmission methods and devices in wireless communication systems, in particular to a method and device for network optimization, service quality improvement, relay communication and etc in communications.

### Related Art

Application scenarios of future wireless communication systems are becoming increasingly diversified, and different application scenarios have different performance demands on systems. In order to meet different performance requirements of various application scenarios, 3rd Generation Partner Project (3GPP) Radio Access Network (RAN) #72th plenary decided to conduct a study of New Radio (NR), or what is called fifth Generation (5G). A work Item (WI) of NR was approved at 3GPP RAN #75th plenary to start standardization work on NR.

In communications, whether Long Term Evolution (LTE) or 5G NR involves features of accurate reception of reliable information, optimized energy efficiency ratio, determination of information efficiency, flexible resource allocation, scalable system structure, efficient non-access layer information processing, low service interruption and dropping rate and support for low power consumption, which are of great significance to the maintenance of normal communications between a base station and a UE, reasonable scheduling of resources and balancing of system payload. Those features can be called the cornerstone of high throughout and are characterized in meeting communication requirements of various service, improving spectrum utilization and improving service quality, which are indispensable in enhanced Mobile BroadBand (eMBB), Ultra Reliable Low Latency Communications (URLLC) and enhanced Machine Type Communications (eMTC). Meanwhile, in the following communication modes, covering Industrial Internet of Things (IIoT), Vehicular to X (V2X), Device to Device communications, Unlicensed Spectrum communications, User communication quality monitoring, network planning optimization, Non-Territorial Networks (NTN), Territorial Networks (TN), and Dual connectivity system, there are extensive requirements in radio resource management and selection of multi-antenna codebooks as well as in signaling design, adjacent cell management, service management and beamforming. Transmission methods of information are divided into broadcast transmission and unicast transmission, both of which are essential for 5G system for that they are very helpful to meet the above requirements. The UE can be connected to the network directly or through a relay.

With the increase of scenarios and complexity of systems, higher requirements are raised for interruption rate and time delay reduction, reliability and system stability enhancement, service flexibility and power saving. At the same time, compatibility between different versions of different systems should be considered when designing the systems.

3GPP standardization organization has done relevant standardization work for 5G and formed a series of standards. The standard contents can be referred to:

https://www.3gpp.org/ftp/Specs/archive/38_series/38.211/38211-g60.zip

https://www.3gpp.org/ftp/Specs/archive/38_series/38.213/38213-g60.zip

https://www.3gpp.org/ftp/Specs/archive/38_series/38.331/38331-g60.zip

https://www.3gpp.org/ftp/Specs/archive/38_series/38.331/38323-g60.zip

### SUMMARY

In various communication scenarios, the use of relay is involved. For example, when a User Equipment (UE) is at the cell edge and the coverage is poor, it can access the network through the relay, and the relay node can be another UE. The relay mainly comprises a Layer 3 relay and a Layer 2 relay (L2 U2N relay), which provide network access services for a remote node (U2N remote UE) through the relay node. The Layer 3 relay is transparent to the access network, that is, the remote UE only establishes a connection with the core network, and the access network cannot identify whether data is from the remote node or the relay node; while for the layer 2 relay; a U2N remote UE and an access network (RAN) have an RRC connection, an access network can manage a remote node, and a radio bearer can be established between the access network and the remote node. The relay can be another UE. In a system that supports the Layer 2 relay, the UE can be in communications with the network through the L2 U2N relay UE, that is, using an indirect path, or directly being in communications with the network without the relay, that is, using a direct path. In some scenarios, a UE can use both direct and indirect paths to obtain better reliability and higher throughput. Direct path and indirect path are different in wireless resource management and network optimization. Direct path and indirect path, one without relay and one with relay; and the relay node may provide services to multiple nodes, so two or more paths may not have the same throughput rate, QoS, and function, which are different from the traditional network structure, and the solution must fit into this new network structure. When a remote UE is in communications with the network via an indirect path, the problem of how to add direct paths needs to be solved if direct paths need to be used at the same time. In the existing technology, a user cannot support two links or paths, that is, if it wants to establish a connection with a cell, it needs to release the previous connection. Adding a direct path is a complex problem; the addition of the direct path involves re-synchronization and performing random access, while relay communications involve new scenarios, i.e., re-establishing a radio link when a higher layer communication connection has already been established, which cannot be supported by existing technology. If the indirect path is interrupted first and then the direct path is established, the reliability will be reduced since the direct path may not be established successfully, most of the UEs that need to use relay are located at the cell edge, and both the direct and indirect paths may not have good signal quality, it is necessary to try to improve the reliability. On the other hand, the network needs to support path switching, i.e., releasing the indirect path first, since one UE can only be connected to one PCell, which ensures a certain degree of flexibility and reduces the complexity of network management. Therefore, the problem to be solved in the present application is how to support multiple paths when using relay. Of course, the solution proposed in this application can also solve other problems in the communication systems, but not limited to the above problems.

To address the above problem, the present application provides a solution.

It should be noted that if no conflict is incurred, embodiments in any node in the present application and the characteristics of the embodiments are also applicable to any other node, and vice versa. And the embodiments in the present application and the characteristics in the embodiments can be arbitrarily combined if there is no conflict.

The present application provides a method in a first node for wireless communications, comprising:
receiving a first signaling via a first air interface, the first signaling comprising a first field, the first field being used to configure a first cell; the first signaling being used to indicate maintaining a first RRC connection, or releasing the first RRC connection; and
as a response to receiving the first signaling, initiating a random access procedure for the first cell via a second air interface;
herein, the first field comprises a second field, and the second field is used to configure the random access procedure for the first cell; the first air interface is an air interface between the first node and a first relay, and the second air interface is an air interface between the first node and a radio access network where the first cell is located; the first RRC connection is a PC5-RRC connection between the first node and the first relay.

In one embodiment, a problem to be solved in the present application comprises: in scenarios where L2 relay is used, how two paths or links are supported ensures both reliability and flexibility in network communications.

In one embodiment, advantages of the above method comprise: supporting simultaneous use of multiple paths to communicate with the network when using L2 relay, reducing interruptions in communications, improving quality of service, improving reliability of network communications, increasing coverage, and better supporting mobility and service continuity.

Specifically, according to one aspect of the present application, as a response to receiving the first signaling, release the first RRC connection; the first cell is an SpCell (Special Cell), the first field is SpCellConfig, and the second field is Reconfiguration WithSync, the first signaling is transmitted through SRB1, the SRB1 is a radio bearer between the first node and a Master Cell Group (MCG), the SRB1 is associated with a first RLC bearer, and the first RLC bearer is an RLC bearer between the first node and the first relay; the first node is connected to the first relay; the behavior of releasing the first RRC connection comprises releasing the first RLC bearer; the first signaling is used to indicate releasing the first RRC connection.

Specifically, according to one aspect of the present application, the first cell is an SpCell, the first field is SpCellConfig, and the second field is Reconfiguration WithSync, the first signaling is transmitted through SRB1, the SRB1 is a radio bearer between the first node and an MCG, the SRB1 is associated with a first RLC bearer, and the first RLC bearer is an RLC bearer between the first node and the first relay; the first node is connected to the first relay; the first signaling is used to indicate maintaining the first RRC connection.

Specifically, according to one aspect of the present application, whether the first signaling comprises a third field is used to indicate whether to maintain the first RRC connection or release the first RRC connection; when the first signaling comprises the third field, the first signaling is used to indicate maintaining the first RRC connection, and when the first signaling does not comprise the third field, the first signaling is used to indicate releasing the first RRC connection.

Specifically, according to one aspect of the present application, the first signaling comprises a fourth field, and the fourth field comprised in the first signaling explicitly indicates whether to release or maintain the first RRC connection.

Specifically, according to one aspect of the present application, the meaning of the phrase that the first signaling is used to indicate maintaining a first RRC connection, or releasing the first RRC connection comprises: when the first signaling indicates that all RBs of the Uu interface are not associated with an RLC bearer between the first node and the first relay, the first signaling is used to indicate releasing the first RRC connection; when the first signaling does not indicate that all RBs of the Uu interface are not associated with an RLC bearer between the first node and the first relay; the first signaling is used to indicate maintaining the first RRC connection.

Specifically, according to one aspect of the present application, the meaning of the phrase that the first signaling is used to indicate maintaining a first RRC connection, or releasing the first RRC connection comprises: when the first signaling indicates releasing all RLC entities for the first relay associated with an RB of the Uu interface, the first signaling is used to indicate releasing the first RRC connection; when the first signaling does not indicate releasing all RLC entities for the first relay associated with an RB of the Uu interface, the first signaling is used to indicate maintaining the first RRC connection.

Specifically, according to one aspect of the present application, the meaning of the phrase that the first signaling is used to indicate maintaining a first RRC connection, or releasing the first RRC connection comprises: when the first signaling indicates that SRB1 is only associated with an RLC entity of the Uu interface, the first signaling is used to indicate releasing the first RRC connection; when the first signaling does not indicate that SRB1 is only associated with an RLC entity of the Uu interface, the first signaling is used to indicate maintaining the first RRC connection.

Specifically, according to one aspect of the present application, the meaning of the phrase that the first signaling is used to indicate maintaining a first RRC connection, or releasing the first RRC connection is: when the first signaling indicates that a destination relay of the first node is a node other than the first relay, the first signaling is used to indicate releasing the first RRC connection, when the first signaling does not indicate a destination relay of the first node or any other node other than the first relay as a destination relay, the first signaling is used to indicate maintaining the first RRC connection.

Specifically, according to one aspect of the present application, as a response to executing the first signaling, start a first timer, as a response to an expiration of the first timer, transmit a target message, the target message is either a first message or a second message, and whether the target message is the first message or the second message is related to whether the first signaling is used to indicate maintaining the first RRC connection or releasing the first RRC connection;

herein, the first message is used to request an RRC connection re-establishment, and the second message is used to report link establishment failure; a stopping condition of the first timer comprises: successfully completing a random access procedure for the first cell; the meaning of the phrase that whether the target message is the first message or the second message is related to whether the first signaling is used to indicate maintaining the first RRC connection or releasing the first RRC connection is: when the first signaling is used to indicate maintaining the first RRC connection, the target message is the second message: when the first signaling is not used to indicate maintaining the first RRC connection, the target message is the first message.

Specifically, according to one aspect of the present application, the first node is an IoT terminal.

Specifically, according to one aspect of the present application, the first node is a relay.

Specifically, according to one aspect of the present application, the first node is a U2N remote UE.

Specifically, according to one aspect of the present application, the first node is a vehicle terminal.

Specifically, according to one aspect of the present application, the first node is an aircraft.

Specifically, according to one aspect of the present application, the first node is a mobile phone.

Specifically, according to one aspect of the present application, the first node is a communication terminal supporting multi-SIM card communications.

The present application provides a first node for wireless communications, comprising:
a first receiver, receiving a first signaling via a first air interface, the first signaling comprising a first field, the first field being used to configure a first cell; the first signaling being used to indicate maintaining a first RRC connection, or releasing the first RRC connection; and
a first transmitter, as a response to receiving the first signaling, initiating a random access procedure for the first cell via a second air interface;
herein, the first field comprises a second field, and the second field is used to configure the random access procedure for the first cell; the first air interface is an air interface between the first node and a first relay, and the second air interface is an air interface between the first node and a radio access network where the first cell is located; the first RRC connection is a PC5-RRC connection between the first node and the first relay.

In one embodiment, the present application has the following advantages over conventional schemes:
supporting configuring a direct path and an indirect path at the same time.
supporting the handling of failure of one of the direct path and the indirect path when they are configured at the same time. In particular, when a bearer or path of one of them fails and the other one is normal, switching of the bearer comprising SRB1 can be implemented to ensure a normal communication and avoid the interruption of communication.
supporting different configurations and processing of radio links connecting cell groups and radio links connecting relays in the network, with functional differentiation, which is beneficial for simplifying the handling of failure and increasing the throughput rate.
when adding another path, the previous path cannot be interrupted, thus ensuring service continuity.
supporting radio bearer, in particular SRB1 uses bearer architecture of split bearer on both direct and indirect paths.
supporting the signaling bearer to use the indirect path as primary path.

### BRIEF DESCRIPTION OF THE DRAWINGS

Other features, objects and advantages of the present application will become more apparent from the detailed description of non-restrictive embodiments taken in conjunction with the following drawings:

FIG. 1 illustrates a flowchart of receiving a first signaling via a first air interface and initiating a random access procedure for a first cell via a second air interface according to one embodiment of the present application;

FIG. 2 illustrates a schematic diagram of a network architecture according to one embodiment of the present application;

FIG. 3 illustrates a schematic diagram of a radio protocol architecture of a user plane and a control plane according to one embodiment of the present application;

FIG. 4 illustrates a schematic diagram of a first communication device and a second communication device according to one embodiment of the present application;

FIG. 5 illustrates a flowchart of radio signal transmission according to one embodiment of the present application;

FIG. 6 illustrates a schematic diagram of a protocol stack for relay communications according to one embodiment of the present application;

FIG. 7 illustrates a schematic diagram of a radio bearer according to one embodiment of the present application;

FIG. 8 illustrates a schematic diagram of a topology according to one embodiment of the present application;

FIG. 9 illustrates a schematic diagram of a processor in a first node according to one embodiment of the present application.

### DESCRIPTION OF THE EMBODIMENTS

The technical scheme of the present application is described below in further details in conjunction with the drawings. It should be noted that the embodiments of the present application and the characteristics of the embodiments may be arbitrarily combined if no conflict is caused.

### Embodiment 1

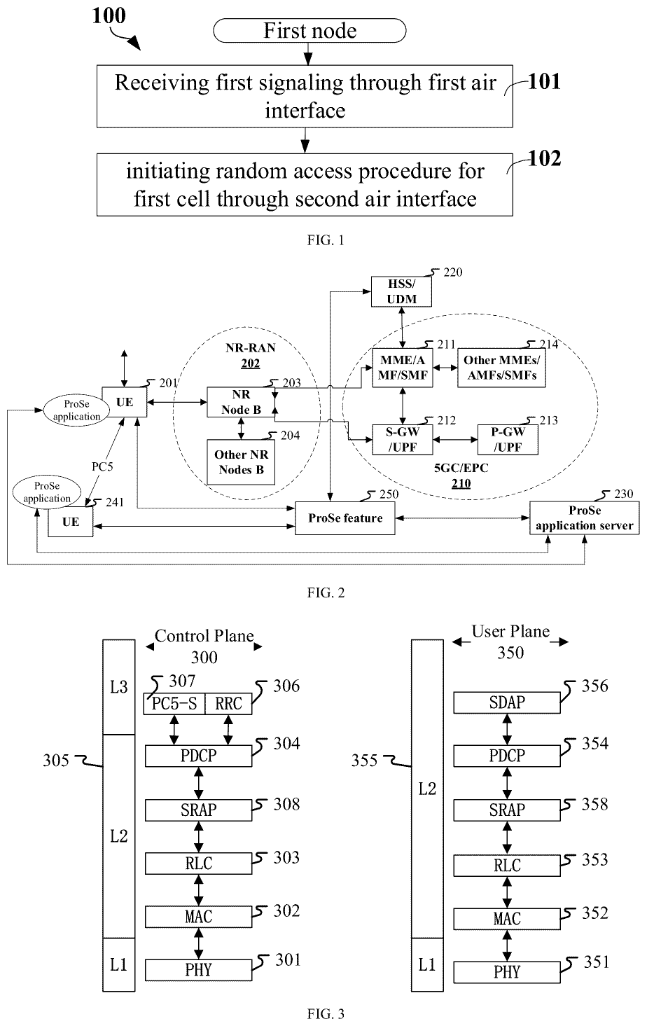

Embodiment 1 illustrates a flowchart of receiving a first signaling via a first air interface and initiating a random access procedure for a first cell via a second air interface according to one embodiment of the present application, as shown in FIG. 1. In FIG. 1, each step represents a step, it should be particularly noted that the sequence order of each box herein does not imply a chronological order of steps marked respectively by these boxes.

In Embodiment 1, the first node in the present application receives a first signaling via a first air interface in step 101, and initiates a random access procedure for the first cell via a second air interface in step 102;

herein, the first signaling comprises a first field, and the first field is used to configure a first cell; the first signaling is used to indicate maintaining a first RRC connection, or releasing the first RRC connection; the first node 100, as a response to receiving the first signaling, initiates a random access procedure for the first cell via a second air interface; the first field comprises a second field, and the second field is used to configure the random access procedure for the first cell; the first air interface is an air interface between the first node and a first relay, and the second air interface is an air interface between the first node and a radio access network where the first cell is located; the first RRC connection is a PC5-RRC connection between the first node and the first relay.

In one embodiment, the first node is a User Equipment (UE).

In one embodiment, the first node is in RRC_CONNECTED state.

In one embodiment, the direct path refers to a transmission path from the UE to the network, and transmission through the direct path means that a transmission of data between the U2N remote UE and the network is not through relay.

In one subembodiment of the above embodiment, the data comprises higher-layer data and signaling.

In one subembodiment of the above embodiment, the data comprises an RRC signaling.

In one subembodiment of the above embodiment, the data comprises a bit string or bit block.

In one subembodiment of the above embodiment, the data only comprises a signaling or data carried by a radio bearer (RB).

In one embodiment, the indirect path refers to a U2N (UE-to-Network) transmission path, where transmission through the indirect path means that data is forwarded between the U2N remote UE and the network via a U2N relay UE.

In one subembodiment of the above embodiment, the data comprises higher-layer data and signaling.

In one subembodiment of the above embodiment, the data comprises an RRC signaling.

In one subembodiment of the above embodiment, the data comprises a bit string or bit block.

In one subembodiment of the above embodiment, the data only comprises a signaling or data carried by a radio bearer (RB).

In one embodiment, a radio link is either the direct path or an indirect path.

In one embodiment, a U2N relay UE refers to a UE providing the function of supporting connectivity of the U2N remote UE to the network.

In one embodiment, a U2N remote UE refers to a UE that needs to be through the U2N relay UE to be in communications with the network.

In one embodiment, a U2N remote UE refers to a UE that needs to be through the U2N relay UE to be in communications with the network.

In one embodiment, a U2N remote UE refers to the UE that supports relay services and is in communications with the network.

In one embodiment, a U2N relay is a U2N relay UE.

In one embodiment, when transmitting and receiving unicast services with the network, both the U2N relay and the U2N remote node are in RRC_CONNECTED state.

In one embodiment, a U2N remote UE is in RRC_IDLE state or RRC_INACTIVE state, and a U2N relay UE can be in any RRC state, comprising RRC_CONNECTED state, RRC_IDLE state and RRC_INACTIVE state.

In one embodiment, a transmission not through a direct path is equal to a transmission through an indirect path.

In one embodiment, a transmission not through a direct path comprises a transmission through relay.

In one embodiment, a transmission through a direct path is or comprises a transmission not through relay.

In one embodiment, a transmission through a direct path is or comprises a forward not through relay.

In one embodiment, a U2N relay UE is a UE providing the functionality of connectivity support to the network for a U2N remote UE.

In one subembodiment of the embodiment, a U2N relay UE is a UE.

In one subembodiment of the embodiment, a U2N relay UE provides U2N remote UE with relay services to network.

In one embodiment, a U2N remote UE is a UE in communications with the network through a U2N relay UE.

In one embodiment, a direct mode is a mode using the direct path.

In one embodiment, the direct mode is a mode in which a U2N remote UE uses the direct path to be in communications with the network.

In one embodiment, the direct mode is a mode in which a U2N remote UE uses the direct path to transmit an RRC signaling or establish an RRC connection with the network.

In one embodiment, an indirect mode is a mode using the indirect path.

In one embodiment, the indirect mode is a mode using the indirect path.

In one embodiment, the direct mode is a mode in which a U2N remote UE uses the indirect path to be in communications with the network.

In one embodiment, the direct mode is a mode in which a U2N remote UE uses the indirect path to transmit an RRC signaling or establish an RRC connection with the network.

In one embodiment, a serving cell refers to a UE-camped cell; executing a cell search comprises: a UE searches for a suitable cell of a selected Public Land Mobile Network (PLMN) or a Stand-alone Non-Public Network (SNPN), selects the suitable cell to provide available traffic, and monitors a control channel of the suitable cell, and this procedure is defined as camping on a cell; that is to say, a camped cell is a serving cell of the UE relative to the UE. It has the following advantages to camp on a cell in RRC idle state or RRC inactive state: enabling the UE to receive a system message from a PLMN or an SNPN; after registration, if the UE wishes to establish an RRC connection or continue a suspended RRC connection, the UE can achieve this by executing an initial access on a control channel of the camping cell; the network may page the UE, which enables the UE to receive Earthquake and Tsunami Warning System (ETWS) and Commercial Mobile Alert System (CMAS) notifications.

In one embodiment, for a U2N remote node, a serving cell is or comprises a cell camped or connected by a U2N relay.

In one embodiment, for a UE in RRC_CONNECTED state that is not configured with carrier aggregation/dual connectivity (CA/DC), only one serving cell comprises a primary cell. For a UE in RRC_CONNECTED state configured with carrier aggregation/dual connectivity (CA/DC), a serving cell is used to indicate a cell set comprising a Special Cell (SpCell) and all sub-cells; a Primary Cell (PCell) is a cell in a Master Cell Group (MCG), which operates at a primary frequency, and the UE performs an initial connection establishment procedure or initiates a connection reconstruction on the primary cell; for dual connectivity, a special cell refers to a Primary Cell (PCell) of an MCG or a Primary SCG Cell (PSCell) of an SCG; if it is not a dual connectivity operation, a special cell refers to a PCell.

In one embodiment, frequency at which a Secondary Cell (SCell) works is sub-frequency.

In one embodiment, an individual content of an information element is called a field.

In one embodiment, a Multi-Radio Dual Connectivity (MR-DC) refers to a dual connectivity between an E-UTRA and an NR node, or a dual connectivity between two NR nodes.

In one embodiment, in MR-DC, a radio access node providing a control-plane connectivity to the core network is a master node, and the master node may be a master eNB, a master ng-eNB, or a master gNB.

In one embodiment, an MCG refers to, in MR-DC, a group of serving cells associated with a master node, comprising an SpCell, and optionally one or multiple SCells.

In one embodiment, a PCell is an SpCell of an MCG.

In one embodiment, a PSCell is an SpCell of an SCG.

In one embodiment, in MR-DC, a control plane connection to the core network is not provided, and a radio access node providing extra resources to the UE is a sub-node. The sub-node can be an en-gNB, a sub-ng-eNB or a sub-gNB.

In one embodiment, in MR-DC, a group of serving cells associated with a sub-node is a Secondary Cell Group (SCG), comprising an SpCell and, optionally, one or multiple SCells.

In one embodiment, an access layer function enabling V2X communications defined in 3GPP standard TS 23.285 is V2X sidelink communication, wherein the V2X sidelink communication occurs between adjacent UEs and uses the E-UTRA technology but does not traverse network nodes.

In one embodiment, an access layer function at least enabling V2X (Vehicle-to-Everything) communication defined in 3GPP standard TS 23.287 is NR sidelink communication, where the NR sidelink communication occurs between two or more adjacent UEs and uses NR technology but does not traverse network nodes.

In one embodiment, sidelink is a direct communication link between UE-to-UE, using sidelink resource allocation mode, and of the physical-layer signal or channel, as well as the physical-layer procedure.

In one embodiment, being not or not being or not being located within coverage is equal to being outside coverage.

In one embodiment, being within coverage is equal to being in coverage.

In one embodiment, being outside coverage is equal to being out of coverage.

In one embodiment, the first node is a U2N remote node.

In one embodiment, PDCP entities corresponding to radio bearers and terminated between UE and network are respectively located in UE and network.

In one embodiment, the direct path is a communication link or a channel or a bearer used during the direct path transmission.

In one embodiment, the direct path transmission refers to that data carried by at least an SRB between the UE and the network is not relayed or forwarded by other nodes.

In one embodiment, the direct path transmission refers to that RLC bearers associated with at least a Signaling radio bearer (SRB) between the UE and the network are respectively terminated at the UE and the network.

In one embodiment, the direct path transmission refers to that RLC entities associated with at least an SRB between UE and network are respectively terminated at the UE and the network.

In one embodiment, the direct path transmission refers to that there exists a direct communication link between the UE and the network.

In one embodiment, the direct path transmission refers to that there exists a Uu interface between the

UE and the network.

In one embodiment, the direct path transmission refers to that there exists a MAC layer of a Uu interface between the UE and the network, and the MAC layer of the Uu interface carries an RRC signaling.

In one embodiment, the direct path transmission refers to that there exists a physical layer of a Uu interface between the UE and the network.

In one embodiment, the direct path transmission refers to that there exists a logical channel and/or transmission channel between the UE and the network.

In one embodiment, the indirect path is an indirect path or a communication link or a channel or a bearer used during the indirect path transmission.

In one embodiment, the indirect path transmission refers to that data carried by at least SRB between the UE and the network is relayed or forwarded by other nodes.

In one embodiment, the indirect path transmission means that RLC bearers associated with at least an SRB between the UE and the network are respectively terminated at the UE and other nodes, as well as other nodes and the network.

In one embodiment, the indirect path transmission means that RLC entities associated with at least an SRB between the UE and the network are respectively terminated at the UE and other nodes, as well as other nodes and the network.

In one embodiment, the meaning of the phrase of at least an SRB comprises at least one of SRB0, SRB1, SRB2, SRB3.

In one embodiment, the meaning of the phrase of at least an SRB comprises an SRB and a data radio bearer (DRB).

In one embodiment, the indirect path transmission refers to that there does not exist a direct communication link between the UE and the network.

In one embodiment, the indirect path transmission refers to that there does not exist a MAC layer of a Uu interface between the UE and the network.

In one embodiment, the indirect path transmission refers to that there does not exist a physical layer of a Uu interface between the UE and the network.

In one embodiment, the indirect path transmission refers to that there does not exist a logical channel nor a transmission channel between the UE and the network.

In one embodiment, the network comprises RAN and/or serving cell and/or base station.

In one embodiment, the UE in the phrase of the UE and the network comprises the first node.

In one embodiment, the other nodes comprise a relay node or other UEs.

In one embodiment, when using a direct path transmission, the UE transmits a physical-layer signaling to the network; when using an indirect path transmission, the UE cannot transmit or directly transmit a physical-layer signaling to the network.

In one embodiment, when using a direct path transmission, the UE transmits a MAC CE to the network; when using an indirect path transmission, the UE cannot transmit or directly transmit a MAC CE to the network.

In one embodiment, when using a direct path transmission, there does not exist other protocol layers between a PDCP layer and an RLC layer of the first node; when using an indirect path transmission, there exist other protocol layers between a PDCP layer and an RLC layer of the first node.

In one subembodiment of the embodiment, the other protocols are or comprise an adaptation layer.

In one embodiment, when using a direct path transmission, the network directly schedules an uplink transmission of the first node through a DCI; when using an indirect path transmission, the network directly schedules an uplink transmission of the first node not through a DCI.

In one embodiment, when using a direct path transmission, an SRB of the first node is associated with an RLC entity and/or an RLC layer and/or an RLC bearer; when using an indirect path transmission, an SRB of the first node is associated with an RLC entity of a PC5 interface.

In one embodiment, when using a direct path transmission, there exists a mapping relation between an SRB of the first node and an RLC entity of a Uu interface; when using an indirect path transmission, there exists a mapping relation between an SRB of the first node and an RLC entity of a PC5 interface.

In one embodiment, there exists a direct path and/or indirect path between the first node and the network.

In one embodiment, the meaning of converting or switching from a direct path to an indirect path is: starting using an indirect path, and stopping using a direct path at the same time.

In one embodiment, the meaning of switching from a direct path to an indirect path is: starting using an indirect path transmission, and stopping using a direct path transmission at the same time.

In one embodiment, the meaning of switching from a direct path to an indirect path is: switching from a direct path transmission to an indirect path transmission.

In one embodiment, the meaning of switching from a direct path to an indirect path is: the first node associates an SRB with an RLC entity of a PC5 interface, and releases an RLC entity of a Uu interface associated with the SRB at the same time.

In one embodiment, the meaning of switching from a direct path to an indirect path is: the first node associates an SRB and a DRB with an RLC entity of a PC5 interface, and releases an RLC entity of a Uu interface associated with the SRB and the DRB at the same time.

In one embodiment, the meaning of switching from an indirect path to a direct path is: starting using a direct path, and stopping using an indirect path at the same time.

In one embodiment, the meaning of switching from an indirect path to a direct path is: starting using a direct path transmission, and stopping using an indirect path transmission at the same time.

In one embodiment, the meaning of switching from an indirect path to a direct path is: switching from an indirect path transmission to a direct path transmission.

In one embodiment, the meaning of switching from an indirect path to a direct path is: the first node releases an RLC entity of a PC5 interface associated with an SRB, and associates an SRB with an RLC entity of a Uu interface.

In one embodiment, the meaning of switching from an indirect path to a direct path is: the first node releases all RLC entities of a PC5 interface associated with a DRB, and associates a DRB with an RLC entity of a Uu interface.

In one embodiment, the first node supports a switch between an indirect path and a direct path.

In one embodiment, when the first node uses an indirect path, a relay used in the indirect path is a first relay.

In one embodiment, a relay in the present application is a U2N relay UE.

In one embodiment, the first node in the present application does not use a dual connectivity (DC).

In one embodiment, the first node in the present application is not configured with DC.

In one embodiment, the first node in the present application only has one cell group.

In one embodiment, the first node in the present application only has one cell group, that is, an MCG.

In one embodiment, the first node in the present application is not configured an SCG.

In one embodiment, relay in the present application refers to an L2 U2N relay UE.

In one embodiment, the first node in the present application uses a direct part and an indirect path at the same time.

In one embodiment, the first air interface is an air interface between the first node and the first relay.

In one embodiment, the first air interface is a PC5 interface.

In one embodiment, a radio link corresponding to the first air interface is sidelink.

In one embodiment, the first air interface uses sidelink resources.

In one embodiment, the first air interface is an air interface between two UEs.

In one embodiment, the first air interface is different from the second air interface.

In one embodiment, the first air interface is a short-range communication interface.

In one embodiment, the first air interface is a Bluetooth interface.

In one embodiment, nodes targeted by the first air interface and the second air interface are not co-located.

In one embodiment, the first air interface comprises a radio link between the first node and the first relay.

In one embodiment, the first air interface comprises a physical channel between the first node and the first relay.

In one embodiment, the first air interface comprises a logical channel between the first node and the first relay.

In one embodiment, the first air interface comprises a transmission channel between the first node and

the first relay.

In one embodiment, the first air interface comprises a direct link between the first node and the first relay.

In one embodiment, the direct link is used for relay services.

In one embodiment, the first air interface comprises a protocol entity used for communications between the first node and the first relay.

In one embodiment, the first relay is an L2 U2N relay UE.

In one embodiment, the first relay is a L2 relay of the first node.

In one embodiment, the first relay is a relay between the first node and the network.

In one embodiment, the first relay is a relay between the first node and the first cell.

In one embodiment, the second air interface is an air interface between the first node and a radio access network where the first cell is located.

In one embodiment, the second air interface is a Uu interface.

In one embodiment, the second air interface corresponds to a main link.

In one embodiment, the second air interface corresponds to a radio link other than sidelink.

In one embodiment, the second air interface corresponds to an air interface between the UE and the RAN (radio access network).

In one embodiment, the second air interface comprises a radio link.

In one embodiment, the second air interface comprises a radio link between the first node and the first cell.

In one embodiment, the second air interface comprises a physical channel between the first node and the first cell.

In one embodiment, the second air interface comprises a transmission channel between the first node and the first cell.

In one embodiment, the second air interface comprises a logical channel between the first node and

the first cell.

In one embodiment, the second air interface comprises a protocol entity between the first node and the first cell.

In one embodiment, both the first air interface and the second air interface are for NR.

In one embodiment, the second air interface is for mobile network.

In one embodiment, the first cell is SpCell (Special Cell).

In one subembodiment of the above embodiment, the first cell is a PCell of the first node.

In one subembodiment of the above embodiment, the first cell is a PSCell of the first node.

In one embodiment, the first field is spCellConfig.

In one embodiment, the first field is spCellConfigDedicated.

In one embodiment, the first field is spCellConfigCommon.

In one embodiment, the first field is condRRCReconfig.

In one embodiment, the second field is Reconfiguration WithSync.

In one embodiment, the second field is RRCReconfiguration.

In one embodiment, the second field is condRRCReconfig.

In one embodiment, the phrase that the first field is used to configure a first cell comprises: the first field is used to configure an identifier of the first cell.

In one embodiment, the phrase that the first field is used to configure a first cell comprises: the first field is used to configure an identity used by the first node in the first cell.

In one embodiment, the phrase that the first field is used to configure a first cell comprises: the first field is used to configure physical-layer resources of the first cell.

In one embodiment, the phrase that the first field is used to configure a first cell comprises: the first field is used to configure at least one timer of the first cell.

In one embodiment, the phrase that the first field is used to configure a first cell comprises: the first field is used to configure frequency of the first cell.

In one embodiment, the phrase that the first field is used to configure a first cell comprises: the first field is used to configure a broadcast message of the first cell.

In one embodiment, the phrase that the first field is used to configure a first cell comprises: the first field is used to configure a radio link monitoring parameter of the first cell.

In one embodiment, the phrase that the first field is used to configure a first cell comprises: the first field is used to configure a measurement for the first cell.

In one embodiment, the phrase that the first field is used to configure a first cell comprises: the first field is used to configure a MAC layer for the first cell.

In one embodiment, the phrase that the first field is used to configure a first cell comprises: the first field is used to configure reference signal resources for the first cell.

In one embodiment, the phrase that the first field is used to configure a first cell comprises: the first field is used to configure a BWP for the first cell.

In one embodiment, the second field is used to configure the random access procedure for the first cell.

In one subembodiment of the above embodiment, the second field comprises random access resources of the first cell.

In one subembodiment of the above embodiment, the second field comprises a preamble sequence for random access of the first cell.

In one subembodiment of the above embodiment, the second field comprises whether a type of a random access procedure for the first cell is contention-based or contention-free.

In one subembodiment of the above embodiment, the second field comprises a priority of a random access procedure for the first cell.

In one subembodiment of the above embodiment, the second field comprises parameters of a timer required in a random access procedure for the first cell.

In one subembodiment of the above embodiment, the second field comprises whether a random access procedure for the first cell is a 2-step random access or a 4-step random access.

In one subembodiment of the above embodiment, the second field comprises an SSB or a CSI-RS associated with a random access procedure for the first cell.

In one embodiment, the meaning of the phrase of a random access procedure for the first cell is, the random access procedure occupies resources of the first cell.

In one embodiment, the meaning of the phrase of a random access procedure for the first cell is, the random access procedure is initiated according to a configuration of a random access of the first cell.

In one embodiment, the meaning of the phrase of a random access procedure for the first cell is, the random access procedure is initiated according to a configuration of a random access channel of the first cell.

In one embodiment, the meaning of the phrase of a random access procedure for the first cell is, the random access procedure is responded by the first cell.

In one embodiment, the first RRC connection is for the first air interface.

In one embodiment, the PC5-RRC connection is an RRC connection for a PC5 air interface.

In one embodiment, the PC5 air interface is an air interface between UE and UE.

In one embodiment, the first RRC connection is an RRC connection between the first node and the first relay.

In one embodiment, a second RRC connection is established between the first node and the first cell.

In one embodiment, an RRC connection established between the first node and the first cell is an RRC connection of the Uu interface.

In one embodiment, an RRC connection function of the PC5 interface is different from an RRC connection function of the Uu interface.

In one embodiment, the first signaling is an RRC signaling.

In one embodiment, the first signaling is or comprises RRCReconfiguration.

In one embodiment, the first signaling is or comprises at least partial fields in an RRCReconfiguration.

In one embodiment, the first node, as a response to receiving the first signaling, releases the first RRC connection;
the first cell is an SpCell, the first field is SpCellConfig, and the second field is Reconfiguration WithSync, the first signaling is transmitted through SRB1, the SRB1 is a radio bearer between the first node and an MCG, the SRB1 is associated with a first RLC bearer, and the first RLC bearer is an RLC bearer between the first node and the first relay; the first node is connected to the first relay; the behavior of releasing the first RRC connection comprises releasing the first RLC bearer; the first signaling is used to indicate releasing the first RRC connection.

In one subembodiment of the above embodiment, a reception of the first signaling triggers the first node to release the first RRC connection.

In one subembodiment of the above embodiment, an execution of the first signaling triggers the first node to release the first RRC connection.

In one subembodiment of the above embodiment, the SRB1 is a radio bearer specifically for transmitting a signaling.

In one subembodiment of the above embodiment, the SRB1 is a radio bearer used for transmitting an RRC signaling.

In one subembodiment of the above embodiment, after establishing an RRC connection with the network, a UE will definitely establish SRB1, and optionally; the network will also configure SRB2 and/or SRB3.

In one subembodiment of the above embodiment, after a UE establishes an RRC connection with the network, the network will configure up to three SRBs for Uu interface, namely SRB1, SRB2, and SRB3.

In one subembodiment of the above embodiment, SRB2 is used for transmitting a security-related signaling or for transmitting an NAS signaling.

In one subembodiment of the above embodiment, when SCG is configured, SRB3 can also be optionally configured for the network.

In one subembodiment of the above embodiment, the meaning of the phrase that the SRB1 is associated with a first RLC bearer is: before executing the first signaling, the SRB1 is associated with the first RLC bearer.

In one subembodiment of the above embodiment, the meaning of the phrase that the SRB1 is associated with a first RLC bearer is: before releasing the first RLC bearer, the SRB1 is associated with the first RLC bearer.

In one subembodiment of the above embodiment, the meaning of the phrase that the SRB1 is associated with a first RLC bearer is: the first RLC bearer has a mapping relation with the SRB1.

In one subembodiment of the above embodiment, the meaning of the phrase that the SRB1 is associated with a first RLC bearer is: the first RLC bearer is used for transmitting a signaling on SRB1.

In one subembodiment of the embodiment, before receiving the first signaling, the SRB1 is only associated with the first RLC bearer.

In one subembodiment of the embodiment, before receiving the first signaling, the SRB1 is only transmitted through the first RLC bearer.

In one subembodiment of the embodiment, the first RLC bearer is an RLC bearer of the PC5 interface.

In one subembodiment of the embodiment, the first RLC bearer is a sidelink RLC bearer.

In one subembodiment of the embodiment, RLC entities corresponding to the first RLC bearer are located within the first node and the first relay, respectively.

In one subembodiment of the embodiment, the first node releases the first RLC bearer at the same time as releasing the first RRC connection.

In one subembodiment of the embodiment, releasing the first RLC bearer is part of releasing the first RRC connection.

In one subembodiment of the embodiment, releasing the first RLC bearer means releasing an RLC entity of the first node and corresponding to the first RLC bearer.

In one embodiment, the first cell is an SpCell, the first field is SpCellConfig, and the second field is Reconfiguration WithSync, the first signaling is transmitted through SRB1, the SRB1 is a radio bearer between the first node and an MCG, the SRB1 is associated with a first RLC bearer, and the first RLC bearer is an RLC bearer between the first node and the first relay; the first node is connected to the first relay; the first signaling is used to indicate maintaining the first RRC connection.

In one subembodiment of the above embodiment, a reception of the first signaling triggers the first node to release the first RRC connection.

In one subembodiment of the above embodiment, an execution of the first signaling triggers the first node to release the first RRC connection.

In one subembodiment of the above embodiment, the SRB1 is a radio bearer specifically for transmitting a signaling.

In one subembodiment of the above embodiment, the SRB1 is a radio bearer used for transmitting an RRC signaling.

In one subembodiment of the above embodiment, after establishing an RRC connection with the network, a UE will definitely establish SRB1, and optionally, the network will also configure SRB2 and/or SRB3.

In one subembodiment of the above embodiment, after a UE establishes an RRC connection with the network, the network will configure up to three SRB for Uu interface, namely SRB1, SRB2, and SRB3.

In one subembodiment of the above embodiment, SRB2 is used for transmitting a security-related signaling or for transmitting an NAS signaling.

In one subembodiment of the above embodiment, when SCG is configured, SRB3 can also be optionally configured for the network.

In one subembodiment of the above embodiment, the meaning of the phrase that the SRB1 is associated with a first RLC bearer is: before executing the first signaling, the SRB1 is associated with the first RLC bearer.

In one subembodiment of the above embodiment, the meaning of the phrase that the SRB1 is associated with a first RLC bearer is: before releasing the first RLC bearer, the SRB1 is associated with the first RLC bearer.

In one subembodiment of the above embodiment, the meaning of the phrase that the SRB1 is associated with a first RLC bearer is: the first RLC bearer has a mapping relation with the SRB1.

In one subembodiment of the above embodiment, the meaning of the phrase that the SRB1 is associated with a first RLC bearer is: the first RLC bearer is used for transmitting a signaling on SRB1.

In one subembodiment of the embodiment, before receiving the first signaling, the SRB1 is only associated with the first RLC bearer.

In one subembodiment of the embodiment, before receiving the first signaling, the SRB1 only performs transmission through the first RLC bearer.

In one subembodiment of the embodiment, the first RLC bearer is an RLC bearer of a PC5 interface.

In one subembodiment of the embodiment, the first RLC bearer is a sidelink RLC bearer.

In one subembodiment of the embodiment, RLC entities corresponding to the first RLC bearer are located within the first node and the first relay, respectively.

In one subembodiment of the embodiment, the first node releases the first RLC bearer at the same time as releasing the first RRC connection.

In one subembodiment of the embodiment, releasing the first RLC bearer is part of releasing the first RRC connection.

In one subembodiment of the embodiment, releasing the first RLC bearer means releasing an RLC entity of the first node and corresponding to the first RLC bearer.

In one embodiment, the first signaling indicates releasing the first RRC connection is: the first signaling does not indicate maintaining the first RRC connection.

In one embodiment, the first signaling indicates maintaining the first RRC connection is: the first signaling does not indicate releasing the first RRC connection.

In one embodiment, the first signaling indicates maintaining the first RRC connection is: the first signaling indicates retaining the first RRC connection.

In one embodiment, when the first signaling is used to indicate releasing the first RRC connection, the first node releases the first RRC connection.

In one embodiment, when the first signaling is used to indicate maintaining the first RRC connection, the first node does not release the first RRC connection.

In one embodiment, when the first signaling is used to indicate maintaining the first RRC connection, the first node continues to use the first RRC connection.

In one embodiment, when the first signaling is used to indicate maintaining the first RRC connection, the first node retains the first RRC connection.

In one embodiment, the behavior of releasing the first RRC connection comprises: releasing the first RLC bearer, the first RLC bearer is an RLC bearer between the first node and the first relay.

In one embodiment, the behavior of releasing the first RRC connection comprises: resetting a MAC for the first relay.

In one embodiment, the behavior of releasing the first RRC connection comprises: it is considered that an RRC connection with the first relay is released.

In one embodiment, the behavior of releasing the first RRC connection comprises: releasing a radio bearer for the first relay.

In one embodiment, the behavior of releasing the first RRC connection comprises: dropping an NR sidelink communication configuration for the first relay.

In one embodiment, the meaning of the phrase that the first node being connected with the first relay comprises: a PC5-RRC connection is established between the first node and the first relay.

In one embodiment, the meaning of the phrase that the first node being connected with the first relay comprises: a relay service relation is established between the first node and the first relay.

In one embodiment, the meaning of the phrase that the first node being connected with the first relay comprises: the first relay becomes an L2 U2N relay of the first node.

In one embodiment, the meaning of the phrase that the first node being connected with the first relay comprises: the first node is connected to the network through the first relay.

In one embodiment, the meaning of the phrase that the first node being connected with the first relay comprises: the first node establishes an RRC connection with the network through the first relay.

In one subembodiment of the above embodiment, the RRC connection is an RRC connection of a Uu interface.

In one embodiment, the first cell is an SpCell (Special Cell).

In one embodiment, the first signaling is transmitted through SRB1, and the SRB1 is a radio bearer between the first node and an MCG.

In one embodiment, the SRB1 is associated with a first RLC bearer, and the first RLC bearer is an RLC bearer between the first node and the first relay.

In one embodiment, the first node is connected to the first relay.

In one embodiment, releasing the first RRC connection comprises releasing the first RLC bearer.

In one embodiment, whether the first signaling comprises a third field is used to indicate whether to maintain the first RRC connection or release the first RRC connection; when the first signaling comprises the third field, the first signaling is used to indicate maintaining the first RRC connection, and when the first signaling does not comprise the third field, the first signaling is used to indicate releasing the first RRC connection.

In one subembodiment of the above embodiment, the first field comprise the third field.

In one subembodiment of the above embodiment, the second field comprise the third field.

In one subembodiment of the above embodiment, the second field does not comprise the third field.

In one subembodiment of the above embodiment, the meaning of the third signaling comprising the third field is: the third present.

In one subembodiment of the above embodiment, the meaning of the third signaling comprising the third field is: the third field being configured.

In one subembodiment of the above embodiment, the third field only has one bit.

In one subembodiment of the above embodiment, a value of the third field only supports true.

In one embodiment, the first signaling comprises a fourth field, and the fourth field comprised in the first signaling explicitly indicates whether to release or maintain the first RRC connection.

In one subembodiment of the above embodiment, the first field comprise the fourth field.

In one subembodiment of the above embodiment, the second field comprise the fourth field.

In one subembodiment of the above embodiment, the second field does not comprise the fourth field.

In one subembodiment of the above embodiment, a value of the fourth field is true or false.

In one subembodiment of the above embodiment, when a value of the fourth field is true, the first signaling is used to indicate releasing the first RRC connection, and when the value of the fourth field is false, the first signaling is used to indicate maintaining the first RRC connection.

In one subembodiment of the above embodiment, when the value of the fourth field is false, the first signaling is used to indicate releasing the first RRC connection, and when a value of the fourth field is true, the first signaling is used to indicate maintaining the first RRC connection.

In one subembodiment of the above embodiment, a value of the fourth field is used to indicate releasing the first RRC connection, and another value of the fourth field is used to indicate maintaining the first RRC connection.

In one embodiment, the fourth field in the first signaling is used to indicate releasing or maintaining the first RRC connection.

In one subembodiment of the above embodiment, when the first signaling does not comprise the fourth field, the first signaling indicates releasing the first RRC connection.

In one subembodiment of the above embodiment, when the first signaling does not comprise the fourth field, the first signaling indicates maintaining the first RRC connection.

In one subembodiment of the above embodiment, when the first signaling comprises the fourth field, a value of the fourth signaling is used to indicate whether to release or maintain the first RRC connection.

In one embodiment, the meaning of the phrase that the first signaling is used to indicate maintaining a first RRC connection, or releasing the first RRC connection comprises: when the first signaling indicates that all RBs of the Uu interface are not associated with an RLC bearer between the first node and the first relay, the first signaling is used to indicate releasing the first RRC connection; when the first signaling does not indicate that all RBs of the Uu interface are not associated with an RLC bearer between the first node and the first relay, the first signaling is used to indicate maintaining the first RRC connection.

In one subembodiment of the above embodiment, the meaning of the phrase that the first signaling indicates that all RBs of a Uu interface are not associated with an RLC bearer between the first node and the first relay is: the first signaling indicates that all radio bearers (RBs) of the Uu interface are not associated with any RLC bearer related to the first relay.

In one subembodiment of the above embodiment, the meaning of the phrase that the first signaling indicates that all RBs of a Uu interface are not associated with an RLC bearer between the first node and the first relay is: the first signaling indicates that all radio bearers (RBs) of the Uu interface associated with an RLC bearer related to the first relay are not associated with any RLC bearer related to the first relay.

In one subembodiment of the above embodiment, the meaning of the phrase that the first signaling indicates that all RBs of a Uu interface are not associated with an RLC bearer between the first node and the first relay is: the first signaling indicates that all radio bearers (RBs) of the Uu interface are only associated with an RLC bearer of the Uu interface.

In one subembodiment of the above embodiment, the meaning of the phrase that the first signaling indicates that all RBs of a Uu interface are not associated with an RLC bearer between the first node and the first relay is: the first signaling indicates that all radio bearers (RBs) of the Uu interface are only associated with an RLC bearer for the first cell.

In one subembodiment of the above embodiment, the meaning of the phrase that the first signaling indicates that all RBs of a Uu interface are not associated with an RLC bearer between the first node and the first relay is: after executing the first signaling, there is no mapping or association relation between any RB of the Uu interface and an RLC bearer for the first relay.

In one subembodiment of the above embodiment, the meaning of the phrase that the first signaling indicates that all RBs of a Uu interface are not associated with an RLC bearer between the first node and the first relay is: after executing the first signaling, there is no mapping or association relation between any RB of the Uu interface and a sidelink RLC bearer.

In one subembodiment of the above embodiment, the meaning of the phrase that the first signaling does not indicate that all RBs of a Uu interface are not associated with an RLC bearer between the first node and the first relay is: after executing the first signaling, there at least exists one mapping relation between an RB of the Uu interface and an RLC bearer of the PC5 interface.

In one subembodiment of the above embodiment, the meaning of the phrase that the first signaling does not indicate that all RBs of a Uu interface are not associated with an RLC bearer between the first node and the first relay is: after executing the first signaling, there at least exists one mapping relation between an RB of the Uu interface and a sidelink RLC bearer.

In one subembodiment of the above embodiment, the meaning of the phrase that the first signaling does not indicate that all RBs of a Uu interface are not associated with an RLC bearer between the first node and the first relay is: after executing the first signaling, there at least exists one mapping relation between an RB of the Uu interface and a sidelink RLC bearer between the first node and the first relay.

In one subembodiment of the above embodiment, the meaning of the phrase that the first signaling does not indicate that all RBs of a Uu interface are not associated with an RLC bearer between the first node and the first relay is: the first signaling does not indicate a change in a mapping relation between an RB of the Uu interface and a sidelink RLC bearer.

In one subembodiment of the above embodiment, the meaning of the phrase that the first signaling does not indicate that all RBs of a Uu interface are not associated with an RLC bearer between the first node and the first relay is: the first signaling indicates that there is a mapping relation between at least one RB of a Uu interface and a sidelink RLC bearer between the first node and the first relay.

In one embodiment, the meaning of the phrase that the first signaling is used to indicate maintaining a first RRC connection, or releasing the first RRC connection comprises: when the first signaling indicates releasing all RLC entities for the first relay associated with an RB of the Uu interface, the first signaling is used to indicate releasing the first RRC connection; when the first signaling does not indicate releasing all RLC entities for the first relay associated with an RB of the Uu interface, the first signaling is used to indicate maintaining the first RRC connection.

In one subembodiment of the above embodiment, the meaning of the phrase that the first signaling indicates releasing all RLC entities for the first relay and associated with an RB of the Uu interface is: after executing the first signaling, any sidelink RLC entity associated with an RB of the Uu interface is released.

In one subembodiment of the above embodiment, the meaning of the phrase that the first signaling indicates releasing all RLC entities for the first relay and associated with an RB of the Uu interface is: after executing the first signaling, any sidelink RLC entity related to the first relay associated with an RB of the Uu interface is released.

In one subembodiment of the above embodiment, the meaning of the phrase that the first signaling indicates releasing all RLC entities for the first relay and associated with an RB of the Uu interface is: after executing the first signaling, all RLC entities associated with an RB of the Uu interface whose peer RLC entities located in the first relay are released.

In one subembodiment of the above embodiment, the meaning of the phrase that the first signaling indicates releasing all RLC entities for the first relay and associated with an RB of the Uu interface is: the first signaling indicates that all RLC entities associated with an RB of the Uu interface for the first relay are released.

In one subembodiment of the above embodiment, the meaning of the phrase that the first signaling indicates releasing all RLC entities for the first relay and associated with an RB of the Uu interface is: after executing the first signaling, any RB of the Uu interface is no longer associated with a sidelink RLC entity.

In one subembodiment of the above embodiment, the meaning of the phrase that the first signaling indicates releasing all RLC entities for the first relay and associated with an RB of the Uu interface is: after executing the first signaling, any RB of the Uu interface is no longer associated with a sidelink RLC entity for the first relay.

In one subembodiment of the above embodiment, the RLC entity for the first relay is an RLC entity where a peer RLC entity is located in the first relay.

In one subembodiment of the above embodiment, the RLC entity for the first relay is an RLC entity corresponding to a first RLC bearer, and the first RLC bearer is an RLC bearer between the first node and the first relay.

In one subembodiment of the above embodiment, the meaning of the phrase that the first signaling does not indicate releasing all RLC entities for the first relay and associated with an RB of the Uu interface is: after executing the first signaling, there at least exists one RB of the Uu interface being associated with a first RLC entity, and the first RLC entity is for the first relay.

In one subembodiment of the above embodiment, the meaning of the phrase that the first signaling does not indicate releasing all RLC entities for the first relay and associated with an RB of the Uu interface is: after executing the first signaling, there at least exists one RB of the Uu interface being associated with a first RLC entity, and the first RLC entity is for the first relay; the meaning of the phrase that the first RLC entity is for the first relay is: a peer RLC entity of the first RLC entity is located in the first relay.

In one subembodiment of the above embodiment, the meaning of the phrase that the first signaling does not indicate releasing all RLC entities for the first relay and associated with an RB of the Uu interface is: the first signaling is used to indicate that at least one RB of the Uu interface is associated with a first RLC entity, and the first RLC entity is for the first relay; the meaning of the phrase that the first RLC entity is for the first relay is: a peer RLC entity of the first RLC entity is located in the first relay.

In one subembodiment of the above embodiment, the RLC entity for the first relay refers to an RLC entity of the first node whose peer RLC entity located at the first node.

In one embodiment, the meaning of the phrase that the first signaling is used to indicate maintaining a first RRC connection, or releasing the first RRC connection comprises: when the first signaling indicates that SRB1 is only associated with an RLC entity of the Uu interface, the first signaling is used to indicate releasing the first RRC connection; when the first signaling does not indicate that SRB1 is only associated with an RLC entity of the Uu interface, the first signaling is used to indicate maintaining the first RRC connection.

In one subembodiment of the above embodiment, the meaning of the phrase that the first signaling indicates that SRB1 is only associated with an RLC entity of the Uu interface is: before executing the first signaling, the SRB1 is associated with an RLC entity for the first relay; after executing the first signaling, the SRB1 is not associated with an RLC entity for the first relay, but only with an RLC entity of the Uu interface.

In one subembodiment of the above embodiment, the RLC entity for the first relay refers to an RLC entity of the first node whose peer RLC entity located at the first relay.

In one subembodiment of the above embodiment, the meaning of the phrase that the first signaling indicates that SRB1 is only associated with an RLC entity of the Uu interface is: before executing the first signaling, the SRB1 is associated with an RLC bearer for the first relay; after executing the first signaling, the SRB1 is not associated with an RLC bearer for the first relay, but only with an RLC bearer of the Uu interface.

In one subembodiment of the above embodiment, the RLC bearer for the first relay refers to an RLC bearer between the first node and the first relay.

In one subembodiment of the above embodiment, the meaning of the phrase that the first signaling does not indicate that SRB1 is only associated with an RLC entity of the Uu interface is: after executing the first signaling, SRB1 is associated with an RLC entity for the first relay.

In one subembodiment of the above embodiment, the meaning of the phrase that the first signaling does not indicate that SRB1 is only associated with an RLC entity of the Uu interface is: after executing the first signaling, SRB1 is associated with an RLC bearer for the first relay.

In one subembodiment of the above embodiment, the meaning of the phrase that the first signaling does not indicate that SRB1 is only associated with an RLC entity of the Uu interface is: the first signaling indicates that SRB1 is associated with an RLC entity for the first relay.

In one subembodiment of the above embodiment, the meaning of the phrase that the first signaling does not indicate that SRB1 is only associated with an RLC entity of the Uu interface is: the first signaling indicates that SRB1 is associated with an RLC bearer for the first relay.

In one subembodiment of the above embodiment, the SRB1 may be associated with only one RLC bearer.

In one subembodiment of the above embodiment, the SRB1 can be associated with only one of an RLC bearer of a Uu interface or an RLC bearer of a PC5 interface.

In one subembodiment of the above embodiment, the SRB1 may be associated with only one of an RLC bearer or a sidelink RLC bearer.

In one embodiment, the meaning of the phrase that the first signaling is used to indicate maintaining a first RRC connection, or releasing the first RRC connection is: when the first signaling indicates that a destination relay of the first node is a node other than the first relay, the first signaling is used to indicate releasing the first RRC connection, when the first signaling does not indicate a destination relay of the first node or any other node other than the first relay as a destination relay, the first signaling is used to indicate maintaining the first RRC connection.

In one subembodiment of the embodiment, the first signaling indicates an identity of a destination relay.

In one subembodiment of the embodiment, the first node is connected to only one L2 U2N relay UE at the same time.

In one subembodiment of the embodiment, a destination relay indicated by the first signaling is for an indirect path between the first node and the first relay.

In one subembodiment of the embodiment, a destination relay indicated by the first signaling is for the first relay.

In one subembodiment of the embodiment, as a response to receiving the first signaling, the first node connects to the destination relay indicated by the first signaling and releases the first RRC connection to the first relay.

In one subembodiment of the embodiment, the first signaling indicates that the destination relay of the first node is the first relay, then the first node maintains the first RRC connection.

In one subembodiment of the embodiment, the destination relay indicated by the first signaling belongs to an L2 U2N relay UE.

### Embodiment 2

Embodiment 2 illustrates a schematic diagram of a network architecture according to the present application, as shown in FIG. 2.

FIG. 2 illustrates a network architecture 200 of 5G NR, Long-Term Evolution (LTE) and Long-Term Evolution Advanced (LTE-A) systems. The 5G NR or LTE network architecture 200 may be called a 5G System (5GS)/Evolved Packet System (EPS) 200 or other appropriate terms. The 5GS/EPS 200 may comprise one or more UEs 201, an NG-RAN 202, a 5G Core Network/Evolved Packet Core (5GC/EPC) 210, a Home Subscriber Server (HSS)/Unified Data Management (UDM) 220 and an Internet Service 230. The 5GS/EPS 200 may be interconnected with other access networks. For simple description, the entities/interfaces are not shown. As shown in FIG. 2, the 5GS/EPS 200 provides packet switching services. Those skilled in the art will readily understand that various concepts presented throughout the present application can be extended to networks providing circuit switching services or other cellular networks. The NG-RAN 202 comprises an NR node B (gNB) 203 and other gNBs 204. The gNB 203 provides UE 201-oriented user plane and control plane protocol terminations. The gNB 203 may be connected to other gNBs 204 via an Xn interface (for example, backhaul). The gNB 203 may be called a base station, a base transceiver station, a radio base station, a radio transceiver, a transceiver function, a Base Service Set (BSS), an Extended Service Set (ESS), a Transmitter Receiver Point (TRP) or some other applicable terms. The gNB 203 provides an access point of the 5GC/EPC 210 for the UE 201. Examples of the UE 201 include cellular phones, smart phones, Session Initiation Protocol (SIP) phones, laptop computers, Personal Digital Assistant (PDA), satellite Radios, non-terrestrial base station communications, Satellite Mobile Communications, Global Positioning Systems (GPS), multimedia devices, video devices, digital audio players (for example, MP3 players), cameras, game consoles, unmanned aerial vehicles (UAV), aircrafts, narrow-band Internet of Things (IoT) devices, machine-type communication devices, land vehicles, automobiles, wearable devices, or any other similar functional devices. Those skilled in the art also can call the UE 201 a mobile station, a subscriber station, a mobile unit, a subscriber unit, a wireless unit, a remote unit, a mobile device, a wireless device, a radio communication device, a remote device, a mobile subscriber station, an access terminal, a mobile terminal, a wireless terminal, a remote terminal, a handset, a user proxy; a mobile client, a client or some other appropriate terms. The gNB 203 is connected to the 5GC/EPC 210 via an S1/NG interface. The 5GC/EPC 210 comprises a Mobility Management Entity (MME)/Authentication Management Field (AMF)/Session Management Function (SMF) 211, other MMEs/AMFs/SMFs 214, a Service Gateway (S-GW)/User Plane Function (UPF) 212 and a Packet Date Network Gateway (P-GW)/UPF 213. The MME/AMF/SMF 211 is a control node for processing a signaling between the UE 201 and the 5GC/EPC 210. Generally, the MME/AMF/SMF 211 provides bearer and connection management. All user Internet Protocol (IP) packets are transmitted through the S-GW/UPF 212, the S-GW/UPF 212 is connected to the P-GW/UPF 213. The P-GW provides UE IP address allocation and other functions. The P-GW/UPF 213 is connected to the Internet Service 230. The Internet Service 230 comprises IP services corresponding to operators, specifically including Internet, Intranet, IP Multimedia Subsystem (IMS) and Packet Switching Streaming Services (PSS).

In one embodiment, the first node in the present application is UE 201.

In one embodiment, a base station of the first node in the present application is gNB 203.

In one embodiment, a wireless link from the UE 201 to NR node B is an uplink.

In one embodiment, a wireless link from NR node B to UE 201 is a downlink.

In one embodiment, the UE 201 supports relay transmission.

In one embodiment, the UE 201 comprises a mobile phone.

In one embodiment, the UE 201 is a vehicle comprising a car.

In one embodiment, the UE 201 supports sidelink communications.

In one embodiment, the UE 201 supports MBS transmission.

In one embodiment, the UE 201 supports MBMS transmission.

In one embodiment, the gNB 203 is a MarcoCellular base station.

In one embodiment, the gNB 203 is a Micro Cell base station.

In one embodiment, the gNB 203 is a PicoCell base station.

In one embodiment, the gNB 203 is a flight platform.

In one embodiment, the gNB 203 is satellite equipment.

### Embodiment 3

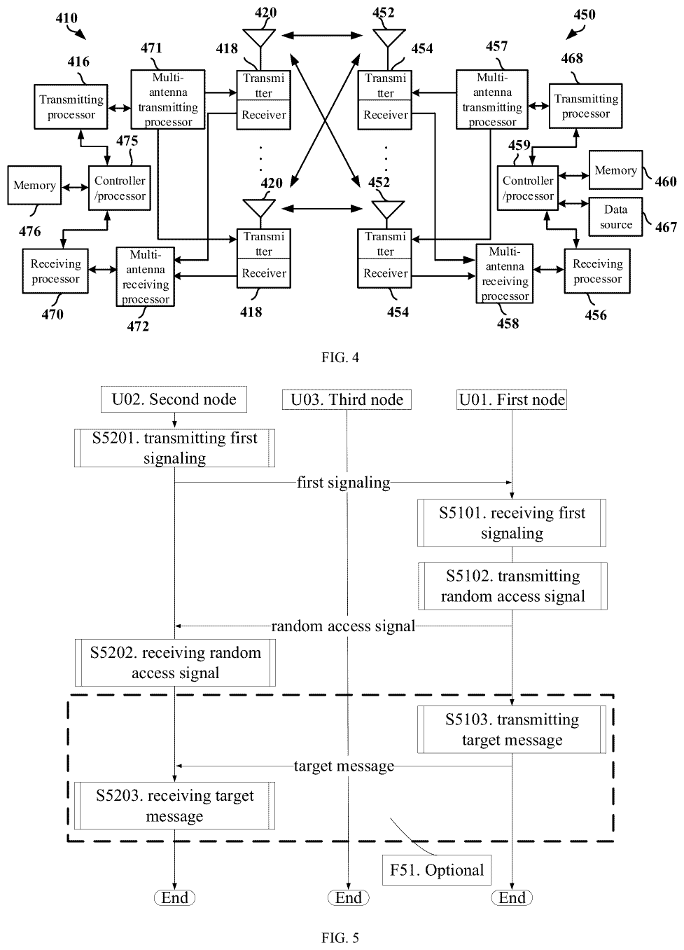

Embodiment 3 illustrates a schematic diagram of an example of a radio protocol architecture of a user plane and a control plane according to one embodiment of the present application, as shown in FIG. 3. FIG. 3 is a schematic diagram illustrating an embodiment of a radio protocol architecture of a user plane 350 and a control plane 300. In FIG. 3, the radio protocol architecture for a first node (UE, gNB or a satellite or an aircraft in NTN) and a second node (gNB, UE or a satellite or an aircraft in NTN), or between two UEs is represented by three layers, which are a layer 1, a layer 2 and a layer 3, respectively. The layer 1 (L1) is the lowest layer and performs signal processing functions of various PHY layers. The L1 is called PHY 301 in the present application. The layer 2 (L2) 305 is above the PHY 301, and is in charge of a link between a first node and a second node, as well as two UEs via the PHY 301. L2 305 comprises a Medium Access Control (MAC) sublayer 302, a Radio Link Control (RLC) sublayer 303 and a Packet Data Convergence Protocol (PDCP) sublayer 304. All the three sublayers terminate at the second node. The PDCP sublayer 304 provides multiplexing among variable radio bearers and logical channels. The PDCP sublayer 304 provides security by encrypting a packet and provides support for a first node handover between second nodes. The RLC sublayer 303 provides segmentation and reassembling of a higher-layer packet, retransmission of a lost packet, and reordering of a data packet so as to compensate the disordered receiving caused by HARQ. The MAC sublayer 302 provides multiplexing between a logical channel and a transmission channel. The MAC sublayer 302 is also responsible for allocating between first nodes various radio resources (i.e., resource block) in a cell. The MAC sublayer 302 is also in charge of HARQ operation. The Radio Resource Control (RRC) sublayer 306 in layer 3 (L3) of the control plane 300 is responsible for acquiring radio resources (i.e., radio bearer) and configuring the lower layer with an RRC signaling between a second node and a first node. PC5 Signaling Protocol (PC5-S) sublayer 307 is responsible for the processing of signaling protocol at PC5 interface. The radio protocol architecture of the user plane 350 comprises layer 1 (L1) and layer 2 (L2). In the user plane 350, the radio protocol architecture for the first node and the second node is almost the same as the corresponding layer and sublayer in the control plane 300 for physical layer 351, PDCP sublayer 354, RLC sublayer 353 and MAC sublayer 352 in L2 layer 355, but the PDCP sublayer 354 also provides a header compression for a higher-layer packet so as to reduce a radio transmission overhead. The L2 layer 355 in the user plane 350 also includes Service Data Adaptation Protocol (SDAP) sublayer 356, which is responsible for the mapping between QoS flow and Data Radio Bearer (DRB) to support the diversity of traffic. SRB can be seen as a service or interface provided by the PDCP layer to a higher layer, such as the RRC layer. In NR system, SRB comprises SRB1, SRB2, SRB3, and when it comes to sidelink communications, there is also SRB4, which is respectively used to transmit different types of control signalings. SRB, a bearer between a UE and access network, is used to transmit a control signaling, comprising an RRC signaling, between UE and access network. SRB1 has special significance for a UE. After each UE establishes an RRC connection, there will be SRB1 used to transmit RRC signaling. Most of the signalings are transmitted through SRB1. If SRB1 is interrupted or unavailable, the UE must perform RRC reconstruction. SRB2 is generally used only to transmit an NAS signaling or signaling related to security aspects. UE cannot configure SRB3. Except for emergency services, a UE must establish an RRC connection with the network for subsequent communications. Although not described in the figure, the first node may comprise several higher layers above the L2 305. also comprises a network layer (i.e., IP layer) terminated at a P-GW 213 of the network side and an application layer terminated at the other side of the connection (i.e., a peer UE, a server, etc.). For UE involving relay service, its control plane can also comprise the adaptation sub-layer Sidelink Relay Adaptation Protocol (SRAP) 308, and its user plane can also comprise the adaptation sub-layer SRAP 358, the introduction of the adaptation layer helps lower layers, such as MAC layer, RLC layer, to multiplex and/or distinguish data from multiple source UEs.

In one embodiment, the radio protocol architecture in FIG. 3 is applicable to the first node in the present application.

In one embodiment, the radio protocol architecture in FIG. 3 is applicable to the second node in the present application.

In one embodiment, the first signaling in the present application is generated by the RRC 306.

In one embodiment, a random access signal in the random access procedure for the first cell in the present application is generated by the PHY 301.

In one embodiment, the first message in the present application is generated by the RRC 306.

In one embodiment, the second message in the present application is generated by the RRC 306.

### Embodiment 4

Embodiment 4 illustrates a schematic diagram of a first communication device and a second communication device according to one embodiment of the present application, as shown in FIG. 4. FIG. 4 is a block diagram of a first communication device 450 in communication with a second communication device 410 in an access network.

The first communication device 450 comprises a controller/processor 459, a memory 460, a data source 467, a transmitting processor 468, a receiving processor 456, optionally may also comprise a multi-antenna transmitting processor 457, a multi-antenna receiving processor 458, a transmitter/receiver 454 and an antenna 452.

The second communication device 410 comprises a controller/processor 475, a memory 476, a receiving processor 470, a transmitting processor 416, optional can also comprise a multi-antenna receiving processor 472, a multi-antenna transmitting processor 471, a transmitter/receiver 418 and an antenna 420.

In a transmission from the second communication device 410 to the first communication device 450, at the first communication device 410, a higher layer packet from the core network is provided to a controller/processor 475. The controller/processor 475 provides a function of the L2 layer. In the transmission from the second communication device 410 to the first communication device 450, the controller/processor 475 provides header compression, encryption, packet segmentation and reordering, and multiplexing between a logical channel and a transmission channel, and radio resources allocation for the first communication device 450 based on various priorities. The controller/processor 475 is also responsible for retransmission of a lost packet and a signaling to the first communication device 450. The transmitting processor 416 and the multi-antenna transmitting processor 471 perform various signal processing functions used for the L1 layer (that is, PHY). The transmitting processor 416 performs coding and interleaving so as to ensure an FEC (Forward Error Correction) at the second communication device 410, and the mapping to signal clusters corresponding to each modulation scheme (i.e., BPSK, QPSK, M-PSK, M-QAM, etc.). The multi-antenna transmitting processor 471 performs digital spatial precoding, including codebook-based precoding and non-codebook-based precoding, and beamforming on encoded and modulated symbols to generate one or more spatial streams. The transmitting processor 416 then maps each spatial stream into a subcarrier. The mapped symbols are multiplexed with a reference signal (i.e., pilot frequency) in time domain and/or frequency domain, and then they are assembled through Inverse Fast Fourier Transform (IFFT) to generate a physical channel carrying time-domain multi-carrier symbol streams. After that the multi-antenna transmitting processor 471 performs transmission analog precoding/beamforming on the time-domain multi-carrier symbol streams. Each transmitter 418 converts a baseband multicarrier symbol stream provided by the multi-antenna transmitting processor 471 into a radio frequency (RF) stream. Each radio frequency stream is later provided to different antennas 420.

In a transmission from the second communication device 410 to the first communication device 450, at the second communication device 450, each receiver 454 receives a signal via a corresponding antenna 452. Each receiver 454 recovers information modulated to the RF carrier, converts the radio frequency stream into a baseband multicarrier symbol stream to be provided to the receiving processor 456. The receiving processor 456 and the multi-antenna receiving processor 458 perform signal processing functions of the L1 layer. The multi-antenna receiving processor 458 performs receiving analog precoding/beamforming on a baseband multicarrier symbol stream from the receiver 454. The receiving processor 456 converts the baseband multicarrier symbol stream after receiving the analog precoding/beamforming from time domain into frequency domain using FFT. In frequency domain, a physical layer data signal and a reference signal are de-multiplexed by the receiving processor 456, wherein the reference signal is used for channel estimation, while the data signal is subjected to multi-antenna detection in the multi-antenna receiving processor 458 to recover any the first communication device-targeted spatial stream. Symbols on each spatial stream are demodulated and recovered in the receiving processor 456 to generate a soft decision. Then the receiving processor 456 decodes and de-interleaves the soft decision to recover the higher-layer data and control signal transmitted on the physical channel by the second communication node 410. Next, the higher-layer data and control signal are provided to the controller/processor 459. The controller/processor 459 performs functions of the L2 layer. The controller/processor 459 can be connected to a memory 460 that stores program code and data. The memory 460 can be called a computer readable medium. In the transmission from the second communication device 410 to the second communication device 450, the controller/processor 459 provides demultiplexing between a transmission channel and a logical channel, packet reassembling, decryption, header decompression and control signal processing so as to recover a higher-layer packet from the core network. The higher-layer packet is later provided to all protocol layers above the L2 layer, or various control signals can be provided to the L3 layer for processing.

In a transmission from the first communication device 450 to the second communication device 410, at the second communication device 450, the data source 467 is configured to provide a higher-layer packet to the controller/processor 459. The data source 467 represents all protocol layers above the L2 layer. Similar to a transmitting function of the second communication device 410 described in the transmission from the second communication device 410 to the first communication device 450, the controller/processor 459 performs header compression, encryption, packet segmentation and reordering, and multiplexing between a logical channel and a transmission channel based on radio resources allocation so as to provide the L2 layer functions used for the user plane and the control plane. The controller/processor 459 is also responsible for retransmission of a lost packet, and a signaling to the second communication device 410. The transmitting processor 468 performs modulation mapping and channel coding. The multi-antenna transmitting processor 457 implements digital multi-antenna spatial precoding, including codebook-based precoding and non-codebook-based precoding, as well as beamforming. Following that, the generated spatial streams are modulated into multicarrier/single-carrier symbol streams by the transmitting processor 468, and then modulated symbol streams are subjected to analog precoding/beamforming in the multi-antenna transmitting processor 457 and provided from the transmitters 454 to each antenna 452. Each transmitter 454 first converts a baseband symbol stream provided by the multi-antenna transmitting processor 457 into a radio frequency symbol stream, and then provides the radio frequency symbol stream to the antenna 452.

In the transmission from the first communication device 450 to the second communication device 410, the function at the second communication device 410 is similar to the receiving function at the first communication device 450 described in the transmission from the second communication device 410 to the first communication device 450. Each receiver 418 receives a radio frequency signal via a corresponding antenna 420, converts the received radio frequency signal into a baseband signal, and provides the baseband signal to the multi-antenna receiving processor 472 and the receiving processor 470. The receiving processor 470 and multi-antenna receiving processor 472 collectively provide functions of the L1 layer. The controller/processor 475 provides functions of the L2 layer. The controller/processor 475 can be connected with the memory 476 that stores program code and data. The memory 476 can be called a computer readable medium. In the transmission from the first communication device 450 to the second communication device 410, the controller/processor 475 provides de-multiplexing between a transmission channel and a logical channel, packet reassembling, decryption, header decompression, control signal processing so as to recover a higher-layer packet from the UE 450. The higher-layer packet coming from the controller/processor 475 may be provided to the core network.

In one embodiment, the first communication device 450 comprises: at least one processor and at least one memory. The at least one memory comprises computer program codes; the at least one memory and the computer program codes are configured to be used in collaboration with the at least one processor, the first communication device 450 at least: receives a first signaling via a first air interface, the first signaling comprises a first field, the first field is used to configure a first cell; the first signaling is used to indicate maintaining a first RRC connection, or releasing the first RRC connection; as a response to receiving the first signaling, initiates a random access procedure for the first cell via a second air interface; herein, the first field comprises a second field, and the second field is used to configure the random access procedure for the first cell; the first air interface is an air interface between the first node and a first relay, and the second air interface is an air interface between the first node and a radio access network where the first cell is located; the first RRC connection is a PC5-RRC connection between the first node and the first relay.

In one embodiment, the first communication device 450 comprises at least one processor and at least one memory. a memory that stores a computer readable instruction program. The computer readable instruction program generates an action when executed by at least one processor. The action includes: receiving a first signaling via a first air interface, the first signaling comprising a first field, the first field being used to configure a first cell; the first signaling being used to indicate maintaining a first RRC connection, or releasing the first RRC connection; as a response to receiving the first signaling, initiating a random access procedure for the first cell via a second air interface: herein, the first field comprises a second field, and the second field is used to configure the random access procedure for the first cell: the first air interface is an air interface between the first node and a first relay, and the second air interface is an air interface between the first node and a radio access network where the first cell is located; the first RRC connection is a PC5-RRC connection between the first node and the first relay.

In one embodiment, the first communication device 450 corresponds to a first node in the present application.

In one embodiment, the second communication device 410 corresponds to a second node in the present application.

In one embodiment, the first communication device 450 is a UE.

In one embodiment, the first communication device 450 is a vehicle terminal.

In one embodiment, the second communication device 450 is a relay.

In one embodiment, the second communication device 410 is a satellite.

In one embodiment, the second communication device 410 is an aircraft.

In one embodiment, the second communication device 410 is a base station.

In one embodiment, the receiver 454 (comprising the antenna 452), the receiving processor 456 and the controller/processor 459 are used to receive the first signaling in the present application.

In one embodiment, the transmitter 454 (comprising antenna 452), the transmitting processor 468 and

the controller/processor 459 are used to transmit the first message in the present application.

In one embodiment, the transmitter 418 (comprising the antenna 420), the transmitting processor 416 and the controller/processor 475 are used to transmit the second message in the present application.

### Embodiment 5

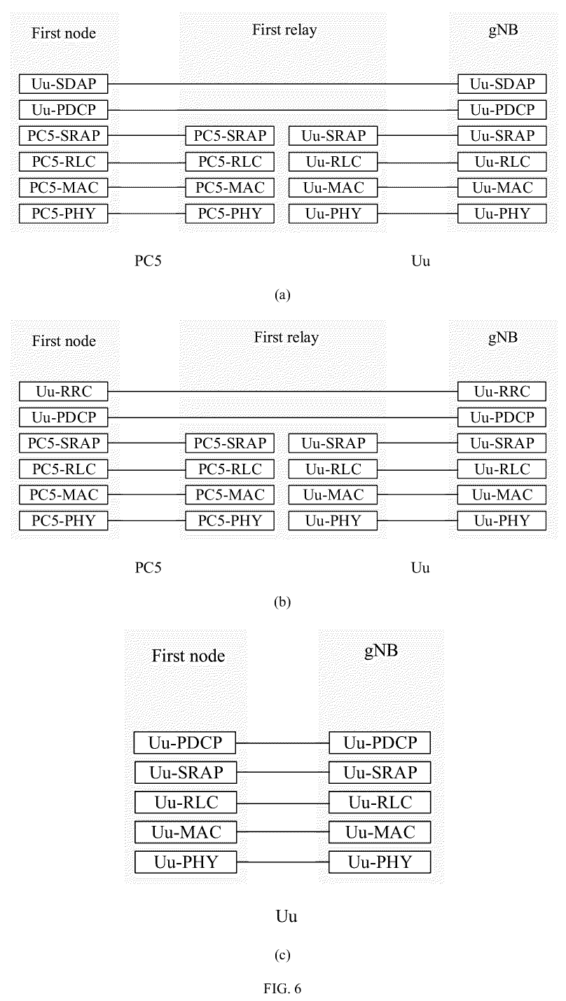

Embodiment 5 illustrates a flowchart of radio signal transmission according to one embodiment in the present application, as shown in FIG. 5. In FIG. 5, U01 corresponds to a first node in the present application. It is particularly underlined that the order illustrated in the embodiment does not put constraints over sequences of signal transmissions and implementations and steps in F51 are optional.

The first node U2 receives a first signaling in step S5101; transmits a random access signal in step S5102; transmits a target message in step S5103.

The second node U02 transmits a first signaling in step S5201; receives a random access signal in step S5202; receives a target message in step S5203.

In embodiment 5, the first node U01 receives a first signaling via a first air interface, the first signaling comprises a first field, the first field is used to configure a first cell; the first signaling is used to indicate maintaining a first RRC connection, or releasing the first RRC connection;

the first node U01, as a response to receiving the first signaling, initiates a random access procedure for the first cell via a second air interface;

herein, the first field comprises a second field, and the second field is used to configure the random access procedure for the first cell; the first air interface is an air interface between the first node and a first relay, and the second air interface is an air interface between the first node and a radio access network where the first cell is located; the first RRC connection is a PC5-RRC connection between the first node and the first relay.

In one embodiment, the first node U01 is a U2N relay UE.

In one embodiment, the first node U01 is a U2N remote UE.

In one embodiment, the first node U01 is an NR ProSe U2N remote UE.

In one embodiment, a third node U03 is the first relay.

In one embodiment, a third node U03 is an L2 U2N relay UE.

In one embodiment, the second node U02 is a base station.

In one embodiment, the second node U02 is an MCG or a base station of an MCG.

In one embodiment, the second node U02 is a PCell of the first node U01.

In one embodiment, the second node U02 is an MCG of the first node U01.

In one embodiment, the second node U02 corresponds to a base station corresponding to a cell group in the present application.

In one embodiment, the second node U02 is the first cell.

In one embodiment, the second node U02 is a base station corresponding to the first cell.

In one embodiment, the second node U02 is a cell group corresponding to the first cell.

In one embodiment, a primary cell of the third node U03 is the second node U02.

In one embodiment, an MCG of the third node U03 is the second node U02.

In one embodiment, the first signaling is transmitted to the first node U01 after forwarding by the third node U03.

In one embodiment, the first node U01 is in communications with the second node U02 using an indirect path, and the indirect path involves or uses the third node U03.

In one embodiment, the first node U01 establishes an RRC connection with the second node U02 before receiving the first signaling.

In one embodiment, the first node U01 is not synchronized with the second node U02 before receiving the first signaling.

In one embodiment, an RRC connection established between the first node U01 and the second node is established through the third node U03.

In one embodiment, the first node U03 transmits a second signaling, and the second signaling is used to feed back the first signaling.

In one subembodiment of the embodiment, the second signaling is an RRC signaling.

In one subembodiment of the embodiment, the second signaling is RRCReconfigurationComplete.

In one subembodiment of the embodiment, the second signaling is forwarded to the second node U02 through the third node U03.

In one subembodiment of the embodiment, the second signaling is directly transmitted to the second node U02.

In one subembodiment of the embodiment, a copy of the second signaling is forwarded to the second node U03 by the third node U03, and a copy of the second signaling is transmitted directly to the second node U02.

In one embodiment, an air interface between the first node U01 and the second node U02 is the second air interface.

In one embodiment, an air interface between the first node U01 and the third node U03 is the first air interface.

In one embodiment, step S5102 belongs to the behavior of initiating a random access procedure for the first cell through a second air interface.

In one embodiment, the random access signal is a physical-layer signal.

In one embodiment, the random access signal is directly transmitted to the second node U02.

In one embodiment, the random access signal is message A in the random access procedure.

In one embodiment, the random access signal is a first one of messages in the random access procedure.

In one embodiment, the random access signal is generated by a sequence.

In one embodiment, the random access signal occupies a random access channel.

In one embodiment, a random access procedure initiated by the first node U01 via a second air interface for the first cell uses a contention-free method.

In one embodiment, a response received on a PDCCH channel is used to determine a successful completion of a random access procedure for the first cell initiated by the first node U01 via a second air interface.

In one subembodiment of the embodiment, the response on the PDCCH channel comprises a signal scrambled by using a C-RNTI scrambling of the first node U01 received on a PDCCH channel.

In one subembodiment of the embodiment, the response on the PDCCH channel comprises receiving a DCI scrambled by using a C-RNTI of the first node U01.

In one embodiment, the first node U01, as a response to executing the first signaling, starts a first timer.

In one embodiment, the first node U01, as a response to an expiration of the first timer, transmits a target message, the target message is either a first message or a second message, and whether the target message is the first message or the second message is related to whether the first signaling is used to indicate maintaining the first RRC connection or releasing the first RRC connection.

In one embodiment, the first node U01, as a response to an expiration of the first timer, transmits a first signaling procedure, the first signaling procedure comprises at least transmitting a target message, the target message is either a first message or a second message, and whether the target message is the first message or the second message is related to whether the first signaling is used to indicate maintaining the first RRC connection or releasing the first RRC connection.

In one embodiment, the first message is used to request an RRC connection re-establishment.

In one embodiment, the second message is used to report link establishment failure.

In one embodiment, a stopping condition of the first timer comprises: successfully completing a random access procedure for the first cell.

In one subembodiment of the embodiment, a signal received on a PDCCH for the first node U01 is used to determine a successful completion of the random access procedure for the first cell.

In one subembodiment of the embodiment, completing a contention resolution in a random access procedure is used to determine a successful completion of a random access procedure for the first cell.

In one embodiment, the meaning of the phrase that whether the target message is the first message or the second message is related to whether the first signaling is used to indicate maintaining the first RRC connection or releasing the first RRC connection is: when the first signaling is used to indicate maintaining the first RRC connection, the target message is the second message; when the first signaling is not used to indicate maintaining the first RRC connection, the target message is the first message.

In one embodiment, the first timer is T304.

In one embodiment, accompanying the behavior of random access procedure for the first cell initiated through the second air interface, the first node U01 starts the first timer.

In one embodiment, the first node U01 fails to detect a signal for the first node U01 on a PDCCH channel before the first timer expires.

In one embodiment, the first node U01 fails to detect a signal of a C-RNTI for the first node U01 on a PDCCH channel before the first timer expires.

In one embodiment, the target message is either the first message or the second message.

In one embodiment, both the first message and the second message are RRC messages.

In one embodiment, the first message comprises RRCReestablishmentRequest.

In one embodiment, the first message comprises RRCConnectionReestablishmentRequest.

In one embodiment, the first message is for the second node U02.

In one embodiment, the first message is through the third node U03.

In one embodiment, the first message is directly transmitted to the second node U02.

In one embodiment, the first message is transmitted to the second node U02 through a relay.

In one embodiment, the first message may also be transmitted to a node other than the second node U02.

In one embodiment, the first message may also be transmitted to a cell other than the first cell.

In one embodiment, when the target message is the first message, the target message may be transmitted to the second node U02 or to a node other than the second node U02, although the latter case is not shown in FIG. 5; when the target message is the second message, the target message is for the second node U02.

In one embodiment, the second message is transmitted to the second node U02 through the forwarding of the third node U03.

In one embodiment, the second message is directly transmitted to the second node U02.

In one embodiment, a name of the second message comprises failure.

In one embodiment, the link establishment failure reported by the second message comprises an expiration of the first timer.

In one embodiment, the link establishment failure reported by the second message comprises a problem with the random access procedure.

In one embodiment, the link establishment failure reported by the second message comprises an unsuccessful RLC establishment.

In one embodiment, the link establishment failure reported by the second message comprises a logical channel identity of a Uu interface indicated by the first signaling.

In one embodiment, the link establishment failure reported by the second message comprises a measurement result for the Uu interface.

In one embodiment, the link establishment failure reported by the second message comprises a measurement result for the first cell.

In one embodiment, the link establishment failure reported by the second message comprises a cause of failure and/or a type of failure.

In one embodiment, the link establishment failure reported by the second message comprises when failure occurs or how long the failure lasts.

In one embodiment, the meaning of the phrase that whether the target message is the first message or the second message is related to whether the first signaling is used to indicate maintaining the first RRC connection or releasing the first RRC connection is: when the first signaling is used to indicate maintaining the first RRC connection, the target message is the second message; when the first signaling indicates releasing the first RRC connection, the target message is the first message.

In one embodiment, when the target message is the first message, the first node U01 releases the first RRC connection before transmitting the first message, and when the target message is the second message, the first node U01 does not release the first RRC connection before transmitting the second message.

In one embodiment, when the target message is the first message, the first node U01 suspends a DRB for the first cell before transmitting the first message, and when the target message is the second message, the first node U01 does not suspend a DRB for the first cell before transmitting the second message.

In one embodiment, when the target message is the first message, the first node U01 resets MAC for the first cell before transmitting the first message, and when the target message is the second message, the first node U01 does not reset MAC for the first cell before transmitting the second message.

In one embodiment, when the target message is the first message, before transmitting the first message, the first node U01 releases a signaling indicated by the first field of the first signaling, and when the target message is the second message, the first node U01 does not release a signaling indicated by the first field of the first signaling before transmitting the second message.

In one embodiment, when the target message is the first message, the first signaling procedure comprises receiving an RRC feedback message of the target message; when the target message is the second message, the first signaling procedure does not comprise receiving an RRC feedback message of the target message.

In one subembodiment of the above embodiment, the meaning of the phrase that the first signaling procedure does not comprise receiving an RRC feedback message of the target message is: the target message has no corresponding feedback message.

### Embodiment 6

Embodiment 6 illustrates a schematic diagram of a protocol stack of relay communications according to one embodiment of the present application, as shown in FIG. 6.

FIG. 6 is divided into three sub-figures (a), (b) and (c).

The protocol stack shown in FIG. 6 is applicable to L2 U2N relay communications, and embodiment 6 is based on embodiment 3.

(a) in FIG. 6 corresponds to the user-plane interface protocol stack in L2 U2N relay communications; (b) in FIG. 6 corresponds to the control-plane interface protocol stack in L2 U2N relay communications.

In one embodiment, a first relay in FIG. 6 is a relay when the first node using an indirect path.

In one embodiment, a first relay in FIG. 6 is a L2 U2N relay UE between the first node and the first cell group, and the first cell group is an MCG of the first node.

In one embodiment, gNB in FIG. 6 is a base station corresponding to the first cell.

In one embodiment, gNB in FIG. 6 is a gNB corresponding to a PCell of the first node or PCell.

In one embodiment, gNB in FIG. 6 is a gNB corresponding to an MCG of the first node or MCG.

In one embodiment, gNB in FIG. 6 is a gNB to which the first node is connected.

In one embodiment, gNB in FIG. 6 has an RRC connection to the first node.

In embodiment 6, a first air interface is an interface between the first node and the first relay, and protocol entities of PC5-SRAP, PC5-RLC, PC5-MAC, PC5-PHY related to the first air interface terminate at the first node and the first relay; a Uu interface is an interface between UE and gNB, and protocol entities of a Uu interface respectively terminate at UE and gNB.

In one embodiment, the first relay is a U2N relay UE, before executing the first signaling, the first relay provides L2 U2N relay services to the first node.

In one embodiment, both the first node and the first relay are UEs.

In one embodiment, the gNB in FIG. 6 corresponds to the second node involved in the present application.

In one embodiment, protocol entities of Uu-SRAP, Uu-RLC, Uu-MAC, Uu-PHY of a Uu interface terminate at the first relay and gNB.

In one embodiment, in (a), protocol entities of Uu-SRAP and Uu-PDCP of a Uu interface terminate at the first node and gNB, an SDAP PDU and a PDCP PDU of the first node are forwarded through the first relay, but the first relay does not modify the SDAP PDU and the PDCP PDU of the first node, i.e., the SDAP PDU and the PDCP PDU transmitted to the gNB by the first node are transmitted transparently for the first relay.

In one embodiment, in (b), protocol entities of Uu-RRC and Uu-PDCP of the Uu interface terminate at the first node and gNB, and an RRC PDU and a PDCP PDU of the first node are forwarded through the first relay, but the first relay does not modify the RRC PDU and the PDCP PDU transmitted by the first node, i.e., the RRC PDU and the PDCP PDU transmitted by the first node to the gNB are transmitted transparently to the first relay.

In one embodiment, in (a), PC5-SRAP corresponds to SRAP357 in FIG. 3, PC5-RLC corresponds to RLC353 in FIG. 3, PC5-MAC corresponds to MAC352 in FIG. 3, and PC5-PHY corresponds to PHY351 in FIG. 3.

In one embodiment, in (a), Uu-SDAP corresponds to SDAP 356 in FIG. 3, and Uu-PDCP corresponds to PDCP 354 in FIG. 3.

In one embodiment, in (b), PC5-SRAP corresponds to SRAP307 in FIG. 3, PC5-RLC corresponds to RLC303 in FIG. 3, PC5-MAC corresponds to MAC302 in FIG. 3, and PC5-PHY corresponds to PHY301 in

FIG. 3.

In one embodiment, in (b), Uu-RRC corresponds to RRC306 in FIG. 3, and Uu-PDCP corresponds to PDCP304 in FIG. 3.

In one embodiment, a cell of the gNB in FIG. 6 is a PCell of the first relay, and the first relay is located in RRC_CONTECTED state.

In one embodiment, the gNB in FIG. 6 manages the first cell, the first cell being a PCell of the first relay.

In one embodiment, an MCG of the first node is also an MCG of the first relay.

In one embodiment, PC5-SRAP is used only for a specific RB or message or data.

In one subembodiment of the embodiment, when the first relay forwards system information of gNB, a PC5-SRAP layer is not used.

In one embodiment, SRB1 of the first node is an SRB1 between the first node and gNB in FIG. 6 (b), and the associated protocol entities comprise Uu-PDCP and Uu-RRC.

In one embodiment, in FIG. 6, communications between the first node and the gNB use an indirect path.

In one embodiment, in FIG. 6, communications between the first node and the gNB use a direct path.

In one embodiment, in FIG. 6, prior to receiving the first signaling, communications between the first node and the gNB use an indirect path, the first signaling is used to indicate that communications between the first node and the gNB use a direct path, and the first signaling is used to indicate whether the first node uses an indirect path to be in communications with the gNB.

In one subembodiment of the embodiment, the meaning of the phrase that the first signaling is used to indicate whether the first node uses an indirect path to be in communications with the gNB comprises that the first signaling is used to indicate whether the first node continues to use or maintains an indirect path to be in communications with the gNB.

In one embodiment, in FIG. 6, after an execution of the first signaling, communications between the first node and the gNB use direct and indirect paths at the same time.

In one embodiment, the first signaling is generated by Uu-RRC of the gNB in FIG. 6 (b), and is received by Uu-RRC of the first node.

In one embodiment, the first signaling is transparent to the first relay.

In one embodiment, a transmission of the first signaling uses the first relay and a transmission of the first signaling is applicable to FIG. 6 (b).

In one embodiment, the first message is applicable to the protocol structure shown in FIG. 6 (b) and/or (c).

In one embodiment, the first message is forwarded to gNB from the first relay.

In one embodiment, when using an indirect path, Uu-PDCP of the first node is associated with PC5-RLC, or is associated with PC5-RLC through PC5-SRAP.

In one embodiment, when using a direct path, the first node will establish Uu-RLC, and Uu-PDCP of the first node is associated with Uu-RLC.

In one subembodiment of the embodiment, after switching to the direct path, the first node releases PC5-RLC.

In one subembodiment of the embodiment, after switching to the direct path, the first node releases PC5-SRAP.

In one subembodiment of the embodiment, after switching to the direct path, the first node releases PC5-MAC and PC5-PHY.

In one subembodiment of the embodiment, after switching to the direct path, the first node not uses PC5-SRAP.

In one subembodiment of the embodiment, after switching to the direct path, there does not exist other protocol layers between Uu-PDCP and Uu-RLC of the first node.

In one embodiment, the first signaling is used to indicate path switch or path adding.

In one embodiment, a radio link corresponding to the first air interface is a second radio link.

In one embodiment, the second radio link comprises a radio link between the first node and the first relay in (a) and/or (b) in FIG. 6.

In one embodiment, the second radio link comprises a sidelink radio link between the first node and the first relay in (a) and/or (b) in FIG. 6.

In one embodiment, the second radio link comprises a sidelink RLC bearer between the first node and the first relay in (a) and/or (b) in FIG. 6.

In one embodiment, the second radio link comprises a transmission channel between the first node and the first relay in (a) and/or (b) in FIG. 6.

In one embodiment, the second radio link comprises a logical channel between the first node and the first relay in (a) and/or (b) in FIG. 6.

In one embodiment, the second radio link comprises a physical channel between the first node and the first relay in (a) and/or (b) in FIG. 6.

In one embodiment, the second radio link comprises a direct unicast link between the first node and the first relay in (a) and/or (b) in FIG. 6.

In one embodiment, the second radio link comprises an interface between a PC5-SRAP entity between the first node and the first relay in (a) and/or (b) in FIG. 6.

In one embodiment, the second radio link comprises a PC5 interface between the first node and the first relay in (a) and/or (b) in FIG. 6.

In one embodiment, (c) in FIG. 6 is a protocol stack of communications between the first node and the gNB when relay is not used.

In one embodiment, (c) in FIG. 6 is a protocol stack for communications between the first node and the gNB when a direct path is used.

In one embodiment, a radio link corresponding to the second air interface is the first radio link.

In one embodiment, the first radio link comprises a radio bearer between the first node in (c) of FIG. 6 and gNB.

In one embodiment, the first radio link comprises a radio link between the first node in (c) of FIG. 6 and gNB.

In one embodiment, the first radio link comprises an RLC bearer between the first node in (c) of FIG. 6 and gNB.

In one embodiment, the first radio link comprises a channel between the first node in (c) of FIG. 6 and

gNB.

In one embodiment, the first radio link comprises a logical channel between the first node in (c) of FIG. 6 and gNB.

In one embodiment, the first radio link comprises a physical channel between the first node in (c) of FIG. 6 and gNB.

In one embodiment, the first radio link comprises a Uu interface between the first node in (c) of FIG. 6 and gNB.

In one embodiment, the second radio link comprises a radio bearer between the first node in (c) of FIG. 6 and gNB.

In one embodiment, the second radio link comprises a radio link between the first node in (c) of FIG. 6 and gNB.

In one embodiment, the second radio link comprises an RLC bearer between the first node in (c) of FIG. 6 and gNB.

In one embodiment, the second radio link comprises a channel between the first node in (c) of FIG. 6 and gNB.

In one embodiment, the second radio link comprises a logical channel between the first node in (c) of FIG. 6 and gNB.

In one embodiment, the second radio link comprises a physical channel between the first node in (c) of FIG. 6 and gNB.

In one embodiment, the second radio link comprises a Uu interface between the first node in (c) of FIG. 6 and gNB.

In one embodiment, a second air interface in FIG. 6 is an air interface between the first node and gNB.

In one embodiment, a second air interface in FIG. 6 is an air interface between the first node and RAN corresponding to gNB.

In one embodiment, a second air interface in FIG. 6 is an air interface between the first node and the first cell managed by gNB.

### Embodiment 7

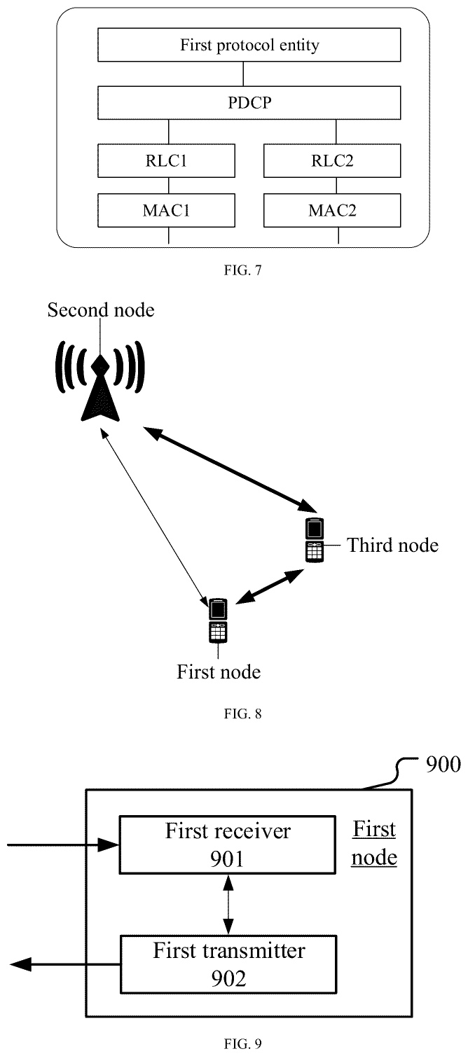

Embodiment 7 illustrates a schematic diagram of a radio bearer according to one embodiment of the present application, as shown in FIG. 7.

Embodiment 7 further illustrates, on the basis of Embodiment 3, a PDCP entity associated with two RLC entities, i.e., RLC1 and RLC2, where each RLC entity is associated with a different MAC, i.e., RLC1 is associated with MAC1 and RLC2 is associated with MAC2

Embodiment 7 illustrates a protocol structure on the first node side.

In one embodiment, the first signaling is used to indicate maintaining the first RRC connection.

In one subembodiment of the embodiment, after executing the first signaling, the first node is in communications with the network using both direct and indirect paths.

In one embodiment, FIG. 7 is for SRB comprising SRB1.

In one embodiment, FIG. 7 is applicable to DRB.

In one embodiment, FIG. 7 is applicable to MRB.

In one embodiment, the protocol structure shown in FIG. 7 is split SRB, that is, split SRB.

In one embodiment, the protocol structure shown in FIG. 7 is split DRB, that is, split DRB.

In one embodiment, FIG. 7 is applicable to transmission.

In one embodiment, FIG. 7 is applicable to reception.

In one embodiment, a first protocol entity in FIG. 7 is RRC, and FIG. 7 is for SRBS comprising SRB1.

In one embodiment, a first protocol entity in FIG. 7 is SDAP, and FIG. 7 is for DRB.

In one embodiment, a PDCP PDU formed by the processing of an RRC message by a PDCP entity is transmitted through RLC1.

In one embodiment, a PDCP PDU formed by the processing of an RRC message by a PDCP entity is transmitted through RLC2.

In one embodiment, a PDCP PDU formed by the processing of an RRC message by a PDCP entity is transmitted through RLC1 or RLC2.

In one embodiment, a PDCP PDU formed by the processing of an RRC message by a PDCP entity is replicated and is transmitted through RLC1 and RLC2 at the same time.

In one embodiment, the SRB1 is used to bear the first signaling and the first message.

In one embodiment, a main path of SRB1 is for RLC1.

In one embodiment, a main path of SRB1 is for RLC2.

In one embodiment, one of RLC1 and RLC2 in FIG. 7 is for the first air interface, and the other is for the second air interface.

In one embodiment, a radio link corresponding to the first air interface is a second radio link, and a radio link corresponding to the second air interface is a first radio link.

In one embodiment, the first radio link is for RLC1.

In one embodiment, the first radio link is associated with RLC1 and MAC1.

In one embodiment, the second radio link is associated with RLC2 and MAC2.

In one embodiment, both RLC2 and MAC2 are for sidelink communications.

In one embodiment, both RLC1 and MAC1 are for main link communications, not for sidelink communications.

In one embodiment, both the RLC1 and MAC1 are for a cell group.

In one embodiment, both the RLC1 and MAC1 are for the first cell or a cell group where the first cell is located.

In one embodiment, the RLC1 and MAC1 are for an MCG.

In one embodiment, releasing the first RRC connection comprises releasing RLC2.

In one embodiment, releasing the first RRC connection comprises resetting MAC2.

In one embodiment, releasing the first RRC connection comprises releasing and deleting MAC2.

### Embodiment 8

Embodiment 8 illustrates a schematic diagram of topological structure according to one embodiment of the present application, as shown in FIG. 8.

A first node in embodiment 8 corresponds to the first node in the present application.

In one embodiment, a second node in embodiment 8 corresponds to a cell group of the first node in the present application.

In one embodiment, a second node in embodiment 8 corresponds to a primary cell of the first node in the present application.

In one embodiment, a second node in Embodiment 8 corresponds to the first cell in the present application or a base station corresponding to the first cell.

In one embodiment, a second node in Embodiment 8 corresponds to a cell group in which the first cell in the present application is located.

In one embodiment, a third node in embodiment 8 is a relay node of the first node.

In one embodiment, a third node in embodiment 8 is a U2N relay of the first node.

In one embodiment, a third node in Embodiment 8 is a relay between the first node and the network.

In one embodiment, a third node in embodiment 8 is the L2 U2N relay UE.

In one embodiment, a third node in Embodiment 8 is a relay node between the first node and the second node.

In one embodiment, a third node in embodiment 8 is an L2 U2N relay UE of the first node.

In one embodiment, a third node in embodiment 8 is the first relay.

In one embodiment, a radio link corresponding to the first air interface is the second radio link; a radio link corresponding to the second air interface is the first radio link.

In one embodiment, the first radio link refers to a bearer between the first node and the second node.

In one embodiment, the first radio link refers to a radio link between the first node and the second node.

In one embodiment, the first radio link refers to an RLC bearer between the first node and the second node.

In one embodiment, the first radio link refers to a communication link between the first node and the second node.

In one embodiment, the first radio link refers to a channel between the first node and the second node.

In one embodiment, the first radio link refers to a communication interface between the first node and the second node.

In one embodiment, the first radio bearer is unrelated to relay.

In one embodiment, the second radio link comprises a radio link between the first node and the third node.

In one embodiment, the second radio link comprises an RLC bearer between the first node and the third node.

In one embodiment, the second radio link comprises a communication link between the first node and the third node.

In one embodiment, the second radio link comprises a channel between the first node and the third node.

In one embodiment, the second radio link comprises a communication interface between the first node and the third node.

In one embodiment, the second radio bearer is related to relay.

In one embodiment, the first radio link is a direct path.

In one embodiment, a link between the first node and the second node that is not forwarded through the third node is a direct path.

In one embodiment, a link between the first node and the second node that is forwarded through the third node is an indirect path.

In one embodiment, a direct path is a way or transmission path in which the first node and the second node are in communications without through the third node.

In one embodiment, an indirect path is a way or transmission path in which the first node and the second node are in communications through the third node.

In one embodiment, the first radio link is or belongs to a direct path.

In one embodiment, the second radio link is an indirect path.

In one embodiment, both the first radio link and the second radio link are for the first node.

In one embodiment, both the first radio link and the second radio link are for data transmission of the first node and the second node.

In one embodiment, the second radio link comprises a transmission path between the first node and the third node as well as between the third node and the second node.

In one embodiment, the second radio link comprises a direct link between the first node and the third node.

In one embodiment, the second radio link comprises a PC5 direct link between the first node and the third node.

In one embodiment, the first radio link comprises a radio link between the first node and the second node.

In one embodiment, the first radio link comprises an RLC bearer between the first node and the second node.

In one embodiment, the first radio link comprises a communication link between the first node and the second node.

In one embodiment, the first radio link comprises a channel between the first node and the second node.

In one embodiment, the first radio link comprises a communication interface between the first node and the second node.

In one embodiment, the second radio link refers to a bearer between the first node and the third node.

In one embodiment, the second radio link refers to a radio link between the first node and the third node.

In one embodiment, the second radio link refers to an RLC bearer between the first node and the third node.

In one embodiment, the second radio link refers to a communication link between the first node and the third node.

In one embodiment, the second radio link refers to a channel between the first node and the third node.

In one embodiment, the second radio link refers to a communication interface between the first node and the third node.

In one embodiment, before receiving the first signaling, there is no first radio link between the first node and the network.

In one embodiment, before receiving the first signaling, communications between the first node and the network do not use the first radio link.

In one embodiment, before receiving the first signaling, communications between the first node and the network are designed only for the second radio link.

In one embodiment, the first signaling is used to indicate whether the second radio link is maintained.

In one embodiment, the first signaling is used to indicate whether the second radio link is released.

In one embodiment, the first signaling is used to indicate whether to use or continue to use the second radio link.

In one embodiment, releasing the first RRC connection comprises releasing or no longer using the second radio link.

### Embodiment 9

Embodiment 9 illustrates a structure block diagram of a processor in a first node according to one embodiment of the present application, as shown in FIG. 9. In FIG. 9, a processor 900 of a first node comprises a first receiver 901 and a first transmitter 902. In Embodiment 9,
the first receiver 901 receives a first signaling via a first air interface, the first signaling comprises a first field, and the first field is used to configure a first cell; the first signaling is used to indicate maintaining a first RRC connection, or releasing the first RRC connection;
the first transmitter 902, as a response to receiving the first signaling, initiates a random access procedure for the first cell via a second air interface;
herein, the first field comprises a second field, and the second field is used to configure the random access procedure for the first cell; the first air interface is an air interface between the first node and a first relay, and the second air interface is an air interface between the first node and a radio access network where the first cell is located; the first RRC connection is a PC5-RRC connection between the first node and the first relay.

In one embodiment, the first receiver 901, as a response to receiving the first signaling, releases the first RRC connection;

the first cell is an SpCell, the first field is SpCellConfig, and the second field is Reconfiguration WithSync, the first signaling is transmitted through SRB1, the SRB1 is a radio bearer between the first node and an MCG, the SRB1 is associated with a first RLC bearer, and the first RLC bearer is an RLC bearer between the first node and the first relay; the first node is connected to the first relay; the behavior of releasing the first RRC connection comprises releasing the first RLC bearer; the first signaling is used to indicate releasing the first RRC connection.

In one embodiment, the first cell is an SpCell, the first field is SpCellConfig, and the second field is Reconfiguration WithSync, the first signaling is transmitted through SRB1, the SRB1 is a radio bearer between the first node and an MCG, the SRB1 is associated with a first RLC bearer, and the first RLC bearer is an RLC bearer between the first node and the first relay; the first node is connected to the first relay; the first signaling is used to indicate maintaining the first RRC connection.

In one embodiment, whether the first signaling comprises a third field is used to indicate whether to maintain the first RRC connection or release the first RRC connection; when the first signaling comprises the third field, the first signaling is used to indicate maintaining the first RRC connection, and when the first signaling does not comprise the third field, the first signaling is used to indicate releasing the first RRC connection.

In one embodiment, the first signaling comprises a fourth field, and the fourth field comprised in the first signaling explicitly indicates whether to release or maintain the first RRC connection.

In one embodiment, the meaning of the phrase that the first signaling is used to indicate maintaining a first RRC connection, or releasing the first RRC connection comprises: when the first signaling indicates that all RBs of the Uu interface are not associated with an RLC bearer between the first node and the first relay, the first signaling is used to indicate releasing the first RRC connection; when the first signaling does not indicate that all RBs of the Uu interface are not associated with an RLC bearer between the first node and the first relay, the first signaling is used to indicate maintaining the first RRC connection.

In one embodiment, the meaning of the phrase that the first signaling is used to indicate maintaining a first RRC connection, or releasing the first RRC connection comprises: when the first signaling indicates releasing all RLC entities for the first relay associated with an RB of the Uu interface, the first signaling is used to indicate releasing the first RRC connection; when the first signaling does not indicate releasing all RLC entities for the first relay associated with an RB of the Uu interface, the first signaling is used to indicate maintaining the first RRC connection.

In one embodiment, the meaning of the phrase that the first signaling is used to indicate maintaining a first RRC connection, or releasing the first RRC connection comprises: when the first signaling indicates that SRB1 is only associated with an RLC entity of the Uu interface, the first signaling is used to indicate releasing the first RRC connection; when the first signaling does not indicate that SRB1 is only associated with an RLC entity of the Uu interface, the first signaling is used to indicate maintaining the first RRC connection.

In one embodiment, the meaning of the phrase that the first signaling is used to indicate maintaining a first RRC connection, or releasing the first RRC connection is: when the first signaling indicates that a destination relay of the first node is a node other than the first relay, the first signaling is used to indicate releasing the first RRC connection, when the first signaling does not indicate a destination relay of the first node or any other node other than the first relay as a destination relay, the first signaling is used to indicate maintaining the first RRC connection.

In one embodiment, the first transmitter 902, as a response to executing the first signaling, starts a first timer, as a response to an expiration of the first timer, transmits a target message, the target message is either a first message or a second message, and whether the target message is the first message or the second message is related to whether the first signaling is used to indicate maintaining the first RRC connection or releasing the first RRC connection;

herein, the first message is used to request an RRC connection re-establishment, and the second message is used to report link establishment failure; a stopping condition of the first timer comprises: successfully completing a random access procedure for the first cell; the meaning of the phrase that whether the target message is the first message or the second message is related to whether the first signaling is used to indicate maintaining the first RRC connection or releasing the first RRC connection is: when the first signaling is used to indicate maintaining the first RRC connection, the target message is the second message; when the first signaling is not used to indicate maintaining the first RRC connection, the target message is the first message.

In one embodiment, the first node is a UE.

In one embodiment, the first node is a terminal that supports large delay differences.

In one embodiment, the first node is a terminal that supports NTN.

In one embodiment, the first node is an aircraft or vessel.

In one embodiment, the first node is a mobile phone or vehicle terminal.

In one embodiment, the first node is a relay UE and/or U2N remote UE.

In one embodiment, the first node is an Internet of Things (IoT) terminal or an Industrial Internet of Things (IIoT) terminal.

In one embodiment, the first node is a device that supports transmission with low-latency and high-reliability.

In one embodiment, the first node is a sidelink communication node.

In one embodiment, the first receiver 901 comprises at least one of the antenna 452, the receiver 454, the receiving processor 456, the multi-antenna receiving processor 458, the controller/processor 459, the memory 460 or the data source 467 in Embodiment 4.

In one embodiment, the first transmitter 902 comprises at least one of the antenna 452, the transmitter 454, the transmitting processor 468, the multi-antenna transmitting processor 457, the controller/processor 459, the memory 460 or the data source 467 in Embodiment 4.

The ordinary skill in the art may understand that all or part of steps in the above method may be implemented by instructing related hardware through a program. The program may be stored in a computer readable storage medium, for example Read-Only Memory (ROM), hard disk or compact disc, etc. Optionally, all or part of steps in the above embodiments also may be implemented by one or more integrated circuits. Correspondingly, each module unit in the above embodiment may be realized in the form of hardware, or in the form of software function modules. The present application is not limited to any combination of hardware and software in specific forms. The UE and terminal in the present application include but not limited to unmanned aerial vehicles, communication modules on unmanned aerial vehicles, telecontrolled aircrafts, aircrafts, diminutive airplanes, mobile phones, tablet computers, notebooks, vehicle-mounted communication equipment, wireless sensor, network cards, terminals for Internet of Things, RFID terminals, NB-IoT terminals, Machine Type Communication (MTC) terminals, enhanced MTC (eMTC) terminals, data cards, low-cost mobile phones, low-cost tablet computers, satellite communication equipment, vessel communication equipment, NTNUEs, etc. The base station or system device in the present application includes but is not limited to macro-cellular base stations, micro-cellular base stations, home base stations, relay base station, gNB (NR node B), Transmitter Receiver Point (TRP), NTN base stations, satellite equipment, flight platform equipment and other radio communication equipment.

This application can be implemented in other designated forms without departing from the core features or fundamental characters thereof. The currently disclosed embodiments, in any case, are therefore to be regarded only in an illustrative, rather than a restrictive sense. The scope of invention shall be determined by the claims attached, rather than according to previous descriptions, and all changes made with equivalent meaning are intended to be included therein.

What is claimed is:

1. A first node for wireless communications, comprising:
a first receiver, receiving a first signaling via a first air interface, the first signaling comprising a first field, the first field being used to configure a first cell; the first signaling being used to indicate maintaining a first RRC (Radio Resource Control) connection, or releasing the first RRC connection; and
a first transmitter, as a response to receiving the first signaling, initiating a random access procedure for the first cell via a second air interface;
wherein the first field comprises a second field, and the second field is used to configure the random access procedure for the first cell; the first air interface is an air interface between the first node and a first relay, and the second air interface is an air interface between the first node and a radio access network where the first cell is located; the first RRC connection is a PC5-RRC connection between the first node and the first relay.

2. The first node according to claim 1, wherein
the first receiver, as a response to receiving the first signaling, releases the first RRC connection;
the first cell is an SpCell (Special Cell), the first field is SpCellConfig, and the second field is Reconfiguration WithSync, the first signaling is transmitted through SRB1 (Signaling Radio Bearer 1), the SRB1 is a radio bearer between the first node and an MCG (Master Cell Group), the SRB1 is associated with a first RLC (Radio Link Control) bearer, and the first RLC bearer is an RLC bearer between the first node and the first relay; the first node is connected to the first relay; the releasing the first RRC connection comprises releasing the first RLC bearer; the first signaling is used to indicate releasing the first RRC connection.

3. The first node according to claim 1, wherein
the first cell is an SpCell, the first field is SpCellConfig, and the second field is Reconfiguration WithSync, the first signaling is transmitted through SRB1, the SRB1 is a radio bearer between the first node and an MCG, the SRB1 is associated with a first RLC bearer, and the first RLC bearer is an RLC bearer between the first node and the first relay; the first node is connected to the first relay; the first signaling is used to indicate maintaining the first RRC connection.

4. The first node according to claim 1, wherein
whether the first signaling comprises a third field is used to indicate whether to maintain the first RRC connection or release the first RRC connection; when the first signaling comprises the third field, the first signaling is used to indicate maintaining the first RRC connection, and when the first signaling does not comprise the third field, the first signaling is used to indicate releasing the first RRC connection.

5. The first node according to claim 2, wherein
whether the first signaling comprises a third field is used to indicate whether to maintain the first RRC connection or release the first RRC connection; when the first signaling comprises the third field, the first signaling is used to indicate maintaining the first RRC connection, and when the first signaling does not comprise the third field, the first signaling is used to indicate releasing the first RRC connection.

6. The first node according to claim 3, wherein
whether the first signaling comprises a third field is used to indicate whether to maintain the first RRC connection or release the first RRC connection; when the first signaling comprises the third field, the first signaling is used to indicate maintaining the first RRC connection, and when the first signaling does not comprise the third field, the first signaling is used to indicate releasing the first RRC connection.

7. The first node according to claim 1, wherein
the first signaling comprises a fourth field, and the fourth field comprised in the first signaling explicitly indicates whether to release or maintain the first RRC connection.

8. The first node according to claim 1, wherein
the meaning of the first signaling being used to indicate maintaining a first RRC connection, or releasing the first RRC connection comprises: when the first signaling indicates that all RBs of the Uu interface are not associated with an RLC bearer between the first node and the first relay, the first signaling is used to indicate releasing the first RRC connection; when the first signaling does not indicate that all RBs of the Uu interface are not associated with an RLC bearer between the first node and the first relay, the first signaling is used to indicate maintaining the first RRC connection.

9. The first node according to claim 4, wherein
the meaning of the first signaling being used to indicate maintaining a first RRC connection, or releasing the first RRC connection comprises: when the first signaling indicates that all RBs of the Uu interface are not associated with an RLC bearer between the first node and the first relay, the first signaling is used to indicate releasing the first RRC connection; when the first signaling does not indicate that all RBs of the Uu interface are not associated with an RLC bearer between the first node and the first relay, the first signaling is used to indicate maintaining the first RRC connection.

10. The first node according to claim 5, wherein
the meaning of the first signaling being used to indicate maintaining a first RRC connection, or releasing the first RRC connection comprises: when the first signaling indicates that all RBs of the Uu interface are not associated with an RLC bearer between the first node and the first relay, the first signaling is used to indicate releasing the first RRC connection; when the first signaling does not indicate that all RBs of the Uu interface are not associated with an RLC bearer between the first node and the first relay, the first signaling is used to indicate maintaining the first RRC connection.

11. The first node according to claim 6, wherein
the meaning of the first signaling being used to indicate maintaining a first RRC connection, or releasing the first RRC connection comprises: when the first signaling indicates that all RBs of the Uu interface are not associated with an RLC bearer between the first node and the first relay, the first signaling is used to indicate releasing the first RRC connection; when the first signaling does not indicate that all RBs of the Uu interface are not associated with an RLC bearer between the first node and the first relay, the first signaling is used to indicate maintaining the first RRC connection.

12. The first node according to claim 1, wherein
the meaning of the first signaling being used to indicate maintaining a first RRC connection, or releasing the first RRC connection comprises: when the first signaling indicates releasing all RLC entities for the first relay associated with an RB of the Uu interface, the first signaling is used to indicate releasing the first RRC connection; when the first signaling does not indicate releasing all RLC entities for the first relay associated with an RB of the Uu interface, the first signaling is used to indicate maintaining the first RRC connection.

13. The first node according to claim 1, wherein
the meaning of the first signaling being used to indicate maintaining a first RRC connection, or releasing the first RRC connection comprises: when the first signaling indicates that SRB1 is only associated with an RLC entity of the Uu interface, the first signaling is used to indicate releasing the first RRC connection; when the first signaling does not indicate that SRB1 is only associated with an RLC entity of the Uu interface, the first signaling is used to indicate maintaining the first RRC connection.

14. The first node according to claim 1, wherein
the meaning of the first signaling being used to indicate maintaining a first RRC connection, or releasing the first RRC connection is: when the first signaling indicates that a destination relay of the first node is a node other than the first relay, the first signaling is used to indicate releasing the first RRC connection, when the first signaling does not indicate a destination relay of the first node or any other node other than the first relay as a destination relay, the first signaling is used to indicate maintaining the first RRC connection.

15. The first node according to claim 1, comprising:
the first transmitter, as a response to executing the first signaling, starting a first timer, as a response to an expiration of the first timer, transmitting a target message, the target message being either a first message or a second message, and whether the target message is the first message or the second message being related to whether the first signaling is used to indicate maintaining the first RRC connection or releasing the first RRC connection;
wherein the first message is used to request an RRC connection re-establishment, and the second message is used to report link establishment failure; a stopping condition of the first timer comprises: successfully completing a random access procedure for the first cell; the meaning of whether the target message is the first message or the second message is related to whether the first signaling is used to indicate maintaining or releasing the first RRC connection is: when the first signaling is used to indicate maintaining the first RRC connection, the target message is the second message; when the first signaling is not used to indicate maintaining the first RRC connection, the target message is the first message.

16. The first node according to claim 4, comprising:
the first transmitter, as a response to executing the first signaling, starting a first timer, as a response to an expiration of the first timer, transmitting a target message, the target message being either a first message or a second message, and whether the target message is the first message or the second message being related to whether the first signaling is used to indicate maintaining the first RRC connection or releasing the first RRC connection;
wherein the first message is used to request an RRC connection re-establishment, and the second message is used to report link establishment failure; a stopping condition of the first timer comprises: successfully completing a random access procedure for the first cell; the meaning of whether the target message is the first message or the second message is related to whether the first signaling is used to indicate maintaining or releasing the first RRC connection is: when the first signaling is used to indicate maintaining the first RRC connection, the target message is the second message; when the first signaling is not used to indicate maintaining the first RRC connection, the target message is the first message.

17. A method in a first node for wireless communications, comprising:
receiving a first signaling via a first air interface, the first signaling comprising a first field, the first field being used to configure a first cell; the first signaling being used to indicate maintaining a first RRC connection, or releasing the first RRC connection; and
as a response to receiving the first signaling, initiating a random access procedure for the first cell via a second air interface;
wherein the first field comprises a second field, and the second field is used to configure the random access procedure for the first cell; the first air interface is an air interface between the first node and a first relay, and the second air interface is an air interface between the first node and a radio access network where the first cell is located; the first RRC connection is a PC5-RRC connection between the first node and the first relay.

18. The method in a first node according to claim 17, wherein
whether the first signaling comprises a third field is used to indicate whether to maintain the first RRC connection or release the first RRC connection; when the first signaling comprises the third field, the first signaling is used to indicate maintaining the first RRC connection, and when the first signaling does not comprise the third field, the first signaling is used to indicate releasing the first RRC connection.

19. The method in a first node according to claim 17, comprising:
as a response to executing the first signaling, starting a first timer, as a response to an expiration of the first timer, transmitting a target message, the target message being either a first message or a second message, and whether the target message is the first message or the second message being related to whether the first signaling is used to indicate maintaining the first RRC connection or releasing the first RRC connection;
wherein the first message is used to request an RRC connection re-establishment, and the second message is used to report link establishment failure; a stopping condition of the first timer comprises: successfully completing a random access procedure for the first cell; the meaning of whether the target message is the first message or the second message is related to whether the first signaling is used to indicate maintaining or releasing the first RRC connection is: when the first signaling is used to indicate maintaining the first RRC connection, the target message is the second message; when the first signaling is not used to indicate maintaining the first RRC connection, the target message is the first message.

20. The method in a first node according to claim 17, wherein
the meaning of the first signaling being used to indicate maintaining a first RRC connection, or releasing the first RRC connection comprises: when the first signaling indicates that all RBs of the Uu interface are not associated with an RLC bearer between the first node and the first relay, the first signaling is used to indicate releasing the first RRC connection; when the first signaling does not indicate that all RBs of the Uu interface are not associated with an RLC bearer between the first node and the first relay, the first signaling is used to indicate maintaining the first RRC connection.
